(19) United States
(12) Patent Application Publication
(10) Pub. No.: US 2024/0209256 A1
(43) Pub. Date: Jun. 27, 2024

(54) METHOD OF PRODUCING NITRIDE FLUORESCENT MATERIAL AND NITRIDE FLUORESCENT MATERIAL

(71) Applicant: NICHIA CORPORATION, Anan-shi (JP)

(72) Inventors: Sadakazu WAKUI, Anan-shi (JP); Kohei KUNIMOTO, Osaka-shi (JP); Hiroyuki WATANABE, Itano-gun (JP); Eishi KANAI, Anan-shi (JP)

(73) Assignee: NICHIA CORPORATION, Anan-shi (JP)

(21) Appl. No.: 18/394,693

(22) Filed: Dec. 22, 2023

(30) Foreign Application Priority Data
Dec. 26, 2022 (JP) 2022-208395
May 19, 2023 (JP) 2023-083237
Sep. 13, 2023 (JP) 2023-148336

(51) Int. Cl. C09K 11/08; C09K 11/77

(52) U.S. Cl. CPC C09K 11/0883; C09K 11/77347

(57) ABSTRACT

A method of producing a nitride fluorescent material includes preparing a calcined product including a fluorescent material core, and a first film containing fluoride on a surface of the fluorescent material core, bringing the calcined product into contact with a solution containing a metal alkoxide containing an element M2 being at least one element selected from the group consisting of Si, Al, Ti, Zr, Sn, and Zn at a temperature equal to or lower than an ambient temperature and hydrolyzing and condensation-polymerizing the metal alkoxide to form a second film containing an oxide containing the element M2, and performing a heat-treatment at a temperature higher than 250° C. and equal to or lower than 500° C. The nitride fluorescent material includes the fluorescent material core having a composition containing an element M^{a} being at least one element selected from the group consisting of Sr, Ca, Ba, and Mg, an element M^{b} being at least one element selected from the group consisting of Li, Na, and K, an element M^{c} being at least one element selected from the group consisting of Eu, Ce, Tb, and Mn, Al, N, and optionally Si.

### CROSS-REFERENCE TO RELATED PATENT APPLICATION

This application claims priority to Japanese Patent Application No. 2022-208395, filed on Dec. 26, 2022, Japanese Patent Application No. 2023-083237, filed on May 19, 2023, and Japanese Patent Application No. 2023-148336, filed on Sep. 13, 2023, the entire disclosures of which are hereby incorporated by references in their entirety.

### BACKGROUND

The present disclosure relates to a method of producing a nitride fluorescent material and a nitride fluorescent material.

Fluorescent materials are used in light emitting devices formed in combination with light emitting diodes (LEDs). Fluorescent materials absorb excitation light emitted from LEDs and emit light having light emission peak wavelengths in a specific wavelength range.

Japanese Translation of PCT International Application Publication No. 2009-526089 discloses a fluorescent material in which the surfaces of fluorescent material crystals or fluorescent material particles are coated with silicon dioxide for protecting fluorescent materials composed of metal sulfides from moisture and other elements.

Nitride fluorescent materials or the like that are different in composition from fluorescent materials composed of metal sulfides are also required to have improved durability in order to reduce deterioration caused by external environments such as humidity and temperature.

Accordingly, one object of the present disclosure is to provide a method of producing a nitride fluorescent material and the nitride fluorescent material that allow for reducing deterioration caused by the external environments and improving the durability of the nitride fluorescent material.

### SUMMARY

According to a first aspect of the present disclosure, a method of producing a nitride fluorescent material includes: preparing a calcined product including a fluorescent material core, and a first film containing fluoride on a surface of the fluorescent material core, bringing the calcined product into contact with a solution containing a metal alkoxide containing an element M2 being at least one element selected from the group consisting of Si, Al, Ti, Zr, Sn, and Zn at a temperature equal to or lower than an ambient temperature and hydrolyzing and condensation-polymerizing the metal alkoxide to form a second film containing an oxide containing the element M2, and performing a heat-treatment at a temperature higher than 250° C. and equal to or lower than 500° C. The nitride fluorescent material includes the fluorescent material core having a composition containing M^{a} being at least one element selected from the group consisting of Sr, Ca, Ba, and Mg; M^{b} being at least one element selected from the group consisting of Li, Na, and K; M^{c} being at least one element selected from the group consisting of Eu, Ce, Tb, and Mn; Al; N; and optionally Si.

According to a second aspect of the present disclosure, a nitride fluorescent material includes Al, N, optionally Si, M^{a} being at least one element selected from the group consisting of Sr, Ca, Ba, and Mg, M^{b} being at least one element selected from the group consisting of Li, Na, and K, and M^{c} being at least one element selected from the group consisting of Eu, Ce, Tb, and Mn; and a film containing an oxide containing an element M2 being at least one element selected from the group consisting of Si, Al, Ti, Zr, Sn, and Zn arranged on the surface of the fluorescent material core, the nitride fluorescent material having a minimum value of a film thickness ratio Tmin/T in a range of 0.3 or more and 1 or less. The film thickness ratio Tmin/T is a ratio of a minimum film thickness Tmin of the film derived from the following formula (2) to a film thickness T of the film derived from the following formula (1):

film thickness T=(S2−Sc)/[(P2+Pc)/2] (1); and

minimum film thickness Tmin=(Ss−Sc)/[(Ps+Pc)/2] (2),
in which, in a scanning electron microscope (SEM) micrograph obtained by photographing the cross-section of the nitride fluorescent material using an SEM, P2 represents an outer circumference length of the film derived from a closed line drawn along the outer circumference of the film to be inscribed on the outer circumference of the film, Pc represents an outer circumference length of the fluorescent material core derived from a closed line drawn along the outer circumference of the fluorescent material core to be inscribed on the outer circumference of the fluorescent material core, Ps represents an outer circumference length of a closed line obtained by enlarging the outer circumference of the fluorescent material core to be inscribed on the outer circumference of the film at the shortest distance from the outer circumference of the fluorescent material core in a direction orthogonal to the outer circumference of the fluorescent material core, S2 represents a cross-sectional area of the fluorescent material core and the film derived from the outer circumference length P2 of the film, Sc represents a cross-sectional area of the fluorescent material core derived from the outer circumference length Pc of the fluorescent material core, and Ss represents a cross-sectional area of the enlarged closed line derived from the outer circumference length Ps.

According to the present disclosure, a method of producing a nitride fluorescent material and the nitride fluorescent material can be provided that allow for reducing deterioration caused by the external environments and improving the durability of the nitride fluorescent material.

### BRIEF DESCRIPTION OF THE DRAWINGS

FIG. 1 is a flowchart describing an exemplary method of producing a nitride fluorescent material.

FIG. 2 is a flowchart describing an exemplary method of producing a nitride fluorescent material.

FIG. 3 is a flowchart describing an exemplary method of producing a nitride fluorescent material.

FIG. 4 is a flowchart describing an exemplary method of producing a nitride fluorescent material.

FIG. 5 is a flowchart describing an exemplary method of producing a nitride fluorescent material.

FIG. 6 is a diagram illustrating a schematic cross-section of a fluorescent material core and a film.

FIG. 7 is a schematic cross-sectional view showing an exemplary light emitting device.

FIG. 8 is an appearance photograph of a nitride fluorescent material obtained by a production method according to Example 4 after a durability test.

FIG. 9 is an appearance photograph of a nitride fluorescent material obtained by a production method according to Comparative Example 1 after a durability test.

FIG. 10 is an SEM micrograph of a reflected electron image of a cross-section of a nitride fluorescent material obtained by a production method according to Example 3.

FIG. 11 is an SEM micrograph of a reflected electron image of a cross-section of a nitride fluorescent material obtained by a production method according to Comparative Example 1.

### DETAILED DESCRIPTION

The method of producing a nitride fluorescent material according to the present disclosure is hereunder described. The embodiments described below are exemplifications for embodying the technical idea of the present disclosure, and the present disclosure is not limited to the method of producing a nitride fluorescent material described below. The relationships between color names and chromaticity coordinates, and the relationships between wavelength ranges of light and color names of monochromic light are in accordance with Japanese Industrial Standard JIS Z8110. In this specification, the “fluorescent material” is used in the same meaning as a “fluorescent phosphor”.

The method of producing a nitride fluorescent material includes preparing a calcined product including a fluorescent material core and a first film, which contains fluoride, on a surface of the fluorescent material core, bringing the calcined product into contact with a solution containing a metal alkoxide containing an element M2 being at least one element selected from the group consisting of Si, Al, Ti, Zr, Sn, and Zn at a temperature equal to or less than an ambient temperature and hydrolyzing and condensation-polymerizing the metal alkoxide to form a second film containing an oxide containing the element M2, and performing heat-treatment at a temperature higher than 250° C. and equal to or lower than 500° C., wherein the nitride fluorescent material includes the fluorescent material core having a composition containing an element M^{a} being at least one element selected from the group consisting of Sr, Ca, Ba, and Mg, an element M^{b} being at least one element selected from the group consisting of Li, Na, and K, an element M^{c} being at least one element selected from the group consisting of Eu, Ce, Tb, and Mn, Al, N, and optionally Si.

In the method of producing a nitride fluorescent material, a calcined product including a fluorescent material core and a first film, which contains fluoride, on a surface of the fluorescent material core is brought into contact with a solution containing a metal alkoxide containing an element M2 to adhere an oxide containing the element M2 on the surface of the first film containing fluoride, thereby forming a second film containing the oxide containing the element M2. By bringing the calcined product into contact with the solution containing the metal alkoxide containing the element M2 at a temperature equal to or lower than an ambient temperature, the hydrolysis and condensation-polymerization of the metal alkoxide proceeds at a relatively slow reaction rate with reduced deterioration of the first film, so that the second film containing an oxide containing the element M2 adheres easily to the first film of the fluorescent material core, and the covering ratio of the second film can be increased. With the second film adhering to the first film on the surface of the fluorescent material core at a large covering ratio, the deterioration of the fluorescent material core due to heat-treatment at a temperature higher than 250° C. and equal to or less than 500° C. after forming the second film can be reduced, so that a nitride fluorescent material having improved durability can be produced. In the nitride fluorescent material obtained by the production method of the present disclosure, the fluorescent material core is covered with the first and second films, which protect the fluorescent material core from the external environments such as humidity and temperature, so that the nitride fluorescent material has improved durability. When the first film containing fluoride formed on the surface of the fluorescent material core is heat-treated at a temperature higher than 250° C. and equal to or less than 500° C. after the second film is formed, the first film becomes integrated with the fluorescent material core, and the boundary between the fluorescent material core and the first film becomes difficult to recognize. Therefore, in the present specification, the “first film” in a state after the formation of the second film and the heat treatment at a temperature higher than 250° C. and equal to or less than 500° C. may be referred to as “a portion having a fluorine-containing composition” of the fluorescent material core. Also, in the present specification, the “second film” in a state after the formation of the second film and the heat treatment at a temperature higher than 250° C. and equal to or less than 500° C. may be referred to as “film containing oxide containing the element M2” or “film containing oxide”.

In the present specification, the covering ratio is calculated as the ratio of the area covered with an oxide to the surface area of the calcined product that includes the first film, containing fluoride, on a surface of the fluorescent material core. In the resulting nitride fluorescent material including the second film, the surface of the calcined product, including the first film on the surface of the fluorescent material core, is covered with an oxide, and thus low-energy characteristic X-rays derived from the calcined product is shielded by the oxide, so that the peak intensity of the low-energy characteristic X-rays is reduced according to the amount of the oxide covering the calcined product. High-energy characteristic X-rays derived from the calcined product is not shielded because of its high penetrability, so that the influence of the oxide covering the surface on a peak intensity of high-energy characteristic X-rays can be ignored. Therefore, by comparing the peak intensity of the characteristic X-rays derived from the calcined product having the first film on the surface of the fluorescent material core and the peak intensity of the characteristic X-rays derived from the nitride fluorescent material having the second film containing the oxide, the covering state of the second film containing the oxide can be evaluated. In a specific example, in X-ray fluorescence (XRF) spectrometry, the relative intensity of the peak intensity of the Kα ray of the Al element relative to the peak intensity of the Kα ray of the Sr element in the calcined product is calculated according to the following formula (3) and is defined as the relative intensity RI₀ of the calcined product having a covering ratio of 0%. The relative intensity RI of the peak intensity of the Kα ray of the Al element relative to the peak intensity of the Kα ray of the Sr element in the nitride fluorescent material on which the second film containing the oxide is formed is calculated according to the following formula (4). The highest relative intensity among a plurality of relative intensities of the nitride fluorescent material is defined as the relative intensity RI₁₀₀ of the nitride fluorescent material having the second film containing the oxide with a covering ratio of 100%, as shown in the formula (4′). On a graph having the relative intensity on the horizontal axis and the covering ratio on the vertical axis, the relative intensity RI₀ and the relative intensity RI₁₀₀ can be plotted to draw a straight line between the relative intensity RI₀ and the relative intensity RI₁₀₀. The relative intensity RI of the peak intensity of the Kα ray of the Al element relative to the peak intensity of the Kα ray of the Sr element in the nitride fluorescent material on which the second film containing the oxide is formed is calculated according to the following formula (4), and the covering ratio of each nitride fluorescent material can be derived from the point where the relative intensity RI and the straight line intersect.

$$Relative intensity {RI}_{o} of calcined product = \frac{K α ray peak intensity of Al element in calcined product}{K α ray peak intensity of Sr element in calcined product} \qquad ( 3 )$$

$$Relative intensity RI of nitride fluorescent material = \frac{\begin{matrix}K α ray peak intensity of Al element \\ in nitride fluorescent material\end{matrix}}{\begin{matrix}K α ray peak intensity of Sr element in \\ nitride fluorescent material\end{matrix}} \qquad ( 4 )$$

$$( 4 )$$

$$Relative intensity {RI}_{100} of nitride fluorescent$$

$$material ( maximum value ) = \frac{\begin{matrix}K α ray peak intensity of Al element \\ in nitride fluorescent material\end{matrix}}{\begin{matrix}K α ray peak intensity of Sr element in \\ nitride fluorescent material\end{matrix}}$$

The higher the value of the covering ratio, the larger the surface area covered by the second film containing the oxide relative to the surface area of the calcined product, in the nitride fluorescent material. The covering ratio may be, for example, 75% or more, preferably 90% or more, or may be 100%. When the covering ratio of the second film in the nitride fluorescent material is 75% or more, the deterioration of the fluorescent material core can be reduced, and the reliability of the light emitting device using the nitride fluorescent material having improved durability can be more effectively improved.

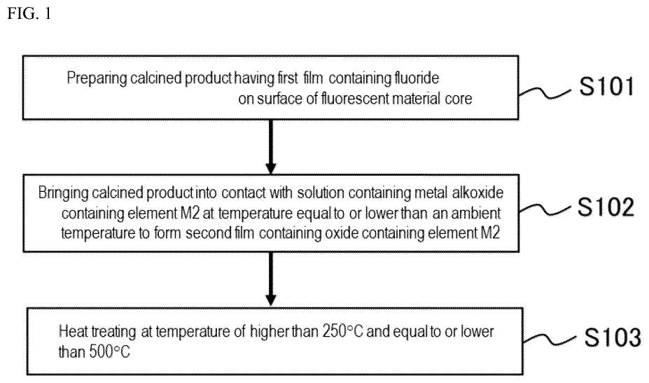

FIG. 1 is a flowchart describing an exemplary method of producing a nitride fluorescent material. The method of producing a nitride fluorescent material includes preparing a calcined product including a fluorescent material core and a first film, which contains fluoride, on a surface of the fluorescent material core (S101), bringing the calcined product into contact with a solution containing a metal alkoxide containing an element M2 at a temperature equal to or lower than an ambient temperature to form a second film containing an oxide containing the element M2 (S102), and heat-treating at a temperature higher than 250° C. and equal to or less than 500° C. (S103).

In the preparing of the calcined product in the method of producing a nitride fluorescent material, the fluorescent material core preferably has a composition represented by the following formula (I).

M^{a}ᵥM^{b}_{w}M^{c}ₓAl_{3-y}Si_{y}N_{z} (I)
wherein M^{a} represents at least one element selected from the group consisting of Sr, Ca, Ba, and Mg; M^{b} represents at least one element selected from the group consisting of Li, Na, and K; M^{c} represents at least one element selected from the group consisting of Eu, Ce, Tb, and Mn; and v, w, x, y, and z satisfy 0.8≤v≤1.2, 0.5≤w≤1.8, 0.001<x≤0.1, 0≤y≤ 0.5, and 1.5≤z≤5.0.

In the fluorescent material core, the element M^{a} in the formula (I) preferably contains at least one of Sr and Ca from the viewpoint of obtaining a high light emission intensity. In the case where the element M^{a} contains at least one of Sr and Ca, the total molar ratio of Sr and Ca contained in the element M^{a} is, for example, 85% by mol or more, preferably 90% by mol or more. The element M^{b} in the formula (I) preferably contains at least Li from the viewpoint of stability of crystal structures. In the case where the element M^{b} in the formula (I) contains Li, the molar ratio of Li contained in the element M^{b} is, for example, 80% by mol or more, preferably 90% by mol or more.

With respect to the values of the parameters v, w, and x in the formula (I), from the viewpoint of stability of crystal structures, the parameter v may be 0.90 or more and 1.03 or less (0.90≤v≤1.03); the parameter w may be 0.90 or more and 1.20 or less (0.90≤w≤ 1.20); and the parameter x may be more than 0.001 and 0.02 or less (0.001<x≤0.020), or may be 0.002 or more and 0.015 or less (0.002≤x≤0.015).

The fluorescent material core can be obtained by mixing raw materials such that the composition contains the element M^{a}, the element M^{b}, the element M^{c}, Al, N, and optionally Si, and then calcining the resulting raw material mixture in an atmosphere containing nitrogen gas, for example, at a temperature equal to or higher than 1,000° C. and equal to or lower than 1,300° C. under a pressure of 0.2 MPa or more and 200 MPa or less. For a method of obtaining a fluorescent material core, for example, the method described in Japanese Unexamined Patent Publication No. 2017-155209 can be used. The raw material mixture may be calcined, for example, in a gas-pressurized electric furnace, the calcining temperature may be equal to or higher than 1,000° C. and equal to or lower than 1,400° C., and the calcination may be carried out in a two-stage calcination in such a manner that the first-stage calcination is carried out at a temperature equal to or higher than 800° C. and equal to or lower than 1,000° C., then the system is gradually heated, and the second-stage calcination is carried out at a temperature equal to or higher than 1,000° C. and equal to or lower than 1,400° C. For a method of obtaining a fluorescent material core, the method described in Japanese Unexamined Patent Publication No. 2019-044039 may also be used.

In the preparing of the calcined product in the method of producing a nitride fluorescent material, the fluorescent material core is preferably subjected to a first heat treatment at a temperature equal to or higher than 120° C. and equal to or lower than 500° C. in an atmosphere containing a fluorine-containing substance to prepare a calcined product including a fluorescent material core and a first film, which contains fluoride, on a surface of the fluorescent material core. When the heat treatment carried out on the fluorescent material core at a temperature equal to or higher than 120° C. and equal to or lower than 500° C. in an atmosphere containing a fluorine-containing substance is referred to as the first heat treatment, the heat treatment carried out at a temperature higher than 250° C. and equal to or lower than 500° C. after the formation of the second film is referred to as the second heat treatment. The atmosphere in which the first heat treatment is carried out is preferably an inert gas atmosphere containing a fluorine-containing substance. The inert gas atmosphere refers to an atmosphere containing argon, helium, or nitrogen as a main component and having a concentration of oxygen contained therein of 15% by volume or less. The inert gas atmosphere may inevitably contain oxygen, and the concentration of oxygen in the inert gas atmosphere is preferably 10% by volume or less, more preferably 5% by volume or less, and even more preferably 1% by volume or less. Examples of the fluorine-containing substance include fluorine gas (F₂) or at least one fluorine compound selected from the group consisting of CHF₃, CF₄, NH₄HF₂, NH₄F, SiF₄, KrF₂, XeF₂, XeF₄, and NF₃. When the fluorine-containing substance is a solid or liquid at room temperature, the fluorescent material core is preferably brought into contact with the fluorine-containing substance in a state where the amount of the fluorine-containing substance is 1% by mass or more and 10% by mass or less relative to 100% by mass of the total amount of the fluorescent material core and the fluorine-containing substance. When the fluorine-containing substance is a gas, the concentration of F₂ in the atmosphere is preferably 2% by volume or more and 25% by volume or less. The temperature of the first heat treatment may be equal to or higher than 120° C. and equal to or lower than 500° C., may be equal to or higher than 150° C. and equal to or lower than 450° C., may be equal to or lower than 400° C., or may be equal to or lower than 350° C. The first heat treatment may be performed for any appropriate time, and is preferably 1 hour or more and 10 hours or less. For preparing the calcined product including a fluorescent material core and a first film, which contains fluoride, on a surface of the fluorescent material core, the method described in Japanese Unexamined Patent Publication No. 2019-044039 is preferably referred to.

In the preparing of the calcined product in the method of producing a nitride fluorescent material, the fluorescent material core may be subjected to a first heat treatment at a temperature equal to or higher than 120° C. and equal to or lower than 500° C. in an atmosphere containing a fluorine-containing substance to prepare a calcined product having a portion having a fluorine-containing composition on the surface of the fluorescent material core.

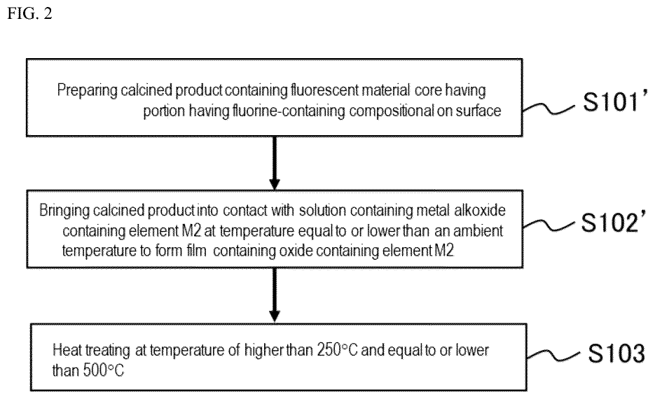

FIG. 2 is a flowchart describing an exemplary method of producing a nitride fluorescent material. The method of producing a nitride fluorescent material includes preparing a calcined product containing a fluorescent material core having a portion having a fluorine-containing composition on the surface (S101′), bringing the calcined product into contact with a solution containing a metal alkoxide containing an element M2 at a temperature equal to or lower than an ambient temperature to form a film containing an oxide containing the element M2 (S102′), and heat-treating at a temperature higher than 250° C. and equal to or lower than 500° C. (S103).

The method of producing a nitride fluorescent material may include bringing the fluorescent material core into contact with an acidic solution prior to carrying out the first heat treatment. By bringing the fluorescent material core into contact with an acidic solution, impurities present on the surface of the fluorescent material core can be dissolved and removed. When impurities are removed from the surface of the fluorescent material core, the first film containing fluoride can be formed in close contact with the surface of the fluorescent material core. The acidic solution is preferably an aqueous solution containing at least one acid selected from the group consisting of nitric acid, hydrochloric acid, acetic acid, sulfuric acid, formic acid, and phosphoric acid. Deionized water can be used as a solvent of the acidic solution. The solvent of the acidic solution may include deionized water and alcohol. The alcohol can use at least one selected from the group consisting of methanol, ethanol, 1-propanol, and 2-propanol. The acidic solution preferably has a pH in a range of 4 to 6, and may have a pH in a range of 3 to 6.5.

In the forming of the second film in the method of producing a nitride fluorescent material, the calcined product may be dispersed in a liquid, and a solution containing a metal alkoxide may be added dropwise to the liquid in which the calcined product is dispersed to bring the calcined product into contact with the solution containing a metal alkoxide. In the present specification, the liquid in which the calcined product is dispersed is also referred to as the reaction solution. Deionized water can be used as a solvent of the reaction solution. The reaction solution uses deionized water as a solvent, and may contain a basic catalyst described below. The reaction solution uses deionized water as a solvent, and may contain ions (M1 ions) composed of an element M1 being at least one element selected from the group consisting of alkali metal elements and alkaline earth metal elements, described below.

In the forming of the second film in the method of producing a nitride fluorescent material, the calcined product is brought into contact with the solution containing a metal alkoxide at a temperature equal to or lower than an ambient temperature, preferably at a temperature higher than the freezing point temperature of the solvent contained in the solution containing a metal alkoxide and/or the solvent contained in the reaction solution in order to prevent solidification of the solution containing a metal alkoxide, it is preferably a temperature. In the forming of the second film in the method of producing a nitride fluorescent material, the calcined product is brought into contact with the solution containing a metal alkoxide preferably at a temperature higher than 0° C. When the solution containing a metal alkoxide is added dropwise to the reaction solution in which the calcined product is dispersed to bring the calcined product into contact with the solution containing a metal alkoxide, the temperature of the reaction solution is preferably a temperature higher than 0° C. and equal to or lower than an ambient temperature. The calcined product has the first film, containing fluoride, on the surface of the fluorescent material core, and even when the calcined product is brought into contact with the solution containing a metal alkoxide in the reaction solution, the metal alkoxide can be hydrolyzed and condensation-polymerized, while reducing deterioration of the fluorescent material core by the first film containing fluoride, to form a second film containing an oxide containing the element M2. The calcined product is brought into contact with the solution containing a metal alkoxide at a temperature equal to or lower than an ambient temperature, which allows for forming the second film containing the oxide containing the element M2 at a relatively slow reaction rate while reducing deterioration of the first film containing fluoride, so that adhesion between the first film and the second film is improved, and the second film is formed with a large covering ratio. The temperature at which the calcined product is brought into contact with the solution containing a metal alkoxide is preferably a temperature lower than the ambient temperature by 10° C. or more, and may be a temperature lower than the ambient temperature by 15° C. or more. In the forming of the second film in the method of producing a nitride fluorescent material, in order to form the second film with a larger covering ratio while reducing deterioration of the first film containing fluoride, the temperature at which the calcined product is brought into contact with the solution containing a metal alkoxide is preferably higher than 0° C. and equal to or lower than 30° C., more preferably higher than 0° C. and equal to or lower than 25° C., even more preferably higher than 0° C. and equal to or lower than 20° C., still more preferably higher than 0° C. and equal to or lower than 15° C., still more preferably higher than 0° C. and equal to or lower than 10° C., particularly preferably higher than 0° C. and lower than 10° C., and may be equal to or higher than 1° C. and equal to or lower than 9° C.

In the forming of the second film in the method of producing a nitride fluorescent material, in order to increase the covering ratio of the second film to the fluorescent material core and the first film, the time of contact of the calcined product with the solution containing a metal alkoxide is preferably 1 hour or more, may be 1.5 hours or more, may be 2 hours or more, and preferably 5 hours or more; and may be 24 hours or less for improving productivity.

The metal alkoxide is a metal alkoxide containing the element M2 being at least one element selected from the group consisting of Si, Al, Ti, Zr, Sn, and Zn. The metal alkoxide is preferably a silane compound having two or more alkoxyl groups. Specific examples of the metal alkoxide include methyltrimethoxysilane, methyltriethoxysilane, ethyltrimethoxysilane, ethyltriethoxysilane, propyltrimethoxysilane, propyltriethoxysilane, tetramethoxysilane, tetraethoxysilane, tetrapropoxysilane, titanium tetrapropoxide, titanium tetrabutoxide, aluminum triethoxide, aluminum tripropoxide, aluminum tributoxide, zirconium tetrapropoxide, zirconium tetrabutoxide, tin tetrabutoxide, zinc tetrapropoxide, and zinc tetrabutoxide. The metal alkoxide is preferably tetraethoxysilane in consideration of workability and availability.

The calcined product is brought into contact with the solution containing the metal alkoxide for hydrolysis and condensation-polymerization of the metal alkoxide, thereby forming a second film containing an oxide containing the metal element M2 on the surface of the calcined product. For example, in the case where the metal alkoxide is tetraethoxysilane (Si(OC₂H₅)₄), the calcined product is brought into contact with a solution containing tetraethoxysilane (Si(OC₂H₅)₄) for hydrolysis of the tetraethoxysilane to form an orthosilicic acid (Si(OH)₄), and then the dehydration reaction proceeds by condensation-polymerization of the orthosilicic acid (Si(OH)₄) to form a second film containing silicon dioxide (SiO₂). The second film contains silicon dioxide (SiO₂) formed by hydrolysis and condensation-polymerization of the tetraethoxysilane, and also partially contains a silicon compound in which hydroxyl groups (OH) remain.

The solution containing the metal alkoxide preferably contains the metal alkoxide in such an amount that the oxide containing the element M2 obtained by hydrolysis and condensation-polymerization of the metal alkoxide is in a range of 5% by mass or more and 20% by mass or less relative to 100% by mass of the calcined product. When the metal alkoxide is contained in the solution such that the oxide containing the element M2 is in the range of 5% by mass or more and 20% by mass or less relative to 100% by mass of the calcined product, the covering ratio of the second film containing the oxide containing the element M2 on the calcined product can be increased. More preferably, the solution containing the metal alkoxide contains the metal alkoxide in an amount in which the oxide containing the element M2 is in a range of 5% by mass or more and 15% by mass or less, even more preferably in a range of 5% by mass or more and 10% by mass or less.

The second film can be formed, for example, by a sol-gel method. The second film may be formed by adhering the solution containing the metal alkoxide to the surface of the calcined product by a chemical vapor deposition (CVD) method, or by adhering the solution containing the metal alkoxide to the surface of the calcined product by an atomic layer deposition (ALD) method.

In the forming of the second film in the method of producing a nitride fluorescent material, ions (hereinafter also referred to as “M1 ions”) composed of the element M1 being at least one element selected from the group consisting of alkali metal elements and alkaline earth metal elements are preferably present when the calcined product is brought into contact with the solution containing the metal alkoxide. The M1 ions preferably include at least one ion selected from the group consisting of Li⁺, Na⁺, K⁺, Rb⁺, Cs⁺, Be²⁺, Sr²⁺, Ca²⁺, Ba²⁺, and Mg²⁺. The presence of ions composed of the element M1 being at least one element selected from the group consisting of alkali metal elements and alkaline earth metal elements when the calcined product is brought into contact with the solution containing the metal alkoxide allows promoting crystallization of the oxide containing the element M2. The M1 ions are preferably ions composed of the element M1 being at least one element selected from the group consisting of alkaline earth metal elements, and preferably include at least one ion selected from the group consisting of Sr²⁺, Ca²⁺, Ba²⁺, and Mg²⁺, of which Sr²⁺ is more preferred. The M1 ions are obtained by dissolving a compound containing the element M1 being at least one element selected from the group consisting of alkali metal elements and alkaline earth metal elements in a reaction solution in which the calcined product is dispersed, and, for example, the solution containing the metal alkoxide may be added dropwise to the reaction solution in which the calcined product is dispersed, so that the M1 ions are present when the calcined product is brought into contact with the solution containing the metal alkoxide. Alternatively, the compound containing the element M1 may be added to the solution containing the metal alkoxide, so that the M1 ions are present when the calcined product is brought into contact with the solution containing the metal alkoxide. The compound containing the element M1 being at least one element selected from the group consisting of alkali metal elements and alkaline earth metal elements, which serves as a source of M1 ions, may be present in a range of 0.03% by mass or more and 0.20% by mass or less, may be present in a range of 0.05% by mass or more and 0.18% by mass or less, or may be present in a range of 0.08% by mass or more and 0.15% by mass or less, relative to 100% by mass of the calcined product, in order to promote crystallization of the oxide containing the element M2. When the compound containing the element M1, which serves as a source of M1 ions, is present in the range of 0.03% by mass or more and 0.20% by mass or less relative to 100% by mass of the calcined product, the crystallization of the oxide containing the element M2 can be further promoted, and the covering ratio of the second film on the calcined material composed of the fluorescent material core having the first film can be increased.

In the forming of the second film in the method of producing a nitride fluorescent material, a basic catalyst is preferably present when the calcined product is brought into contact with the solution containing the metal alkoxide. The presence of a basic catalyst when the calcined product is brought into contact with the solution containing the metal alkoxide allows promoting the reaction of hydrolysis and condensation-polymerization of the metal alkoxide even at a temperature lower than the ambient temperature, thereby forming a second film containing an oxide containing the element M2 with a large covering ratio on the calcined product. Examples of the basic catalyst are not particularly limited, and may include at least one selected from the group consisting of ammonium, ammonium carbonate, ammonium hydrogencarbonate, ammonium formate, ammonium acetate, sodium carbonate, and sodium hydrogencarbonate. The basic catalyst may be added to a reaction solution in which the calcined product is dispersed, so that the basic catalyst is present when the calcined product is brought into contact with the solution containing the metal alkoxide. Alternatively, the basic catalyst may be added to the solution containing the metal alkoxide, so that the basic catalyst is present when the calcined product is brought into contact with the solution containing the metal alkoxide. When the basic catalyst is added to the reaction solution or the solution containing the metal alkoxide, a compound serving as the basic catalyst may be added to each solution in a range of 0.001 mol/L or more and 1.0 mol/L or less.

In the forming of the second film in the method of producing a nitride fluorescent material, the solution containing the metal alkoxide preferably contains water and/or alcohol. The solution containing the metal alkoxide preferably contains water and/or alcohol as a solvent. The water may be deionized water. The alcohol may be at least one selected from the group consisting of methanol, ethanol, 1-propanol, and 2-propanol.

The method of producing a nitride fluorescent material preferably includes drying after bringing the calcined product into contact with the solution containing the metal alkoxide in the forming of the second film. When the calcined product is dried after being brought into contact with the solution containing the metal alkoxide, the element M2 is bonded to the surface of the fluorescent material core and the first film in a state containing a hydroxyl group (OH), and subsequent heat treatment removes hydrogen from the hydroxyl group (OH) to form a second film that is in close contact with the first film on the fluorescent material core. The drying may be carried out using a commonly used industrial device such as a hot air dryer, a vacuum dryer, a conical dryer, a rotary evaporator, or a spray dryer. The drying temperature is preferably in a range of equal to or higher than 50° C. and equal to or lower than 120° C., more preferably in a range of equal to or higher than 60° C. and equal to or lower than 115° C., and even more preferably in a range of equal to or higher than 70° C. and equal to or lower than 110° C. The drying time can be performed for any appropriate time, and is preferably 1 hour or more and 30 hours or less, more preferably 2 hours or more and 25 hours or less, and even more preferably 3 hours or more and 24 hours or less.

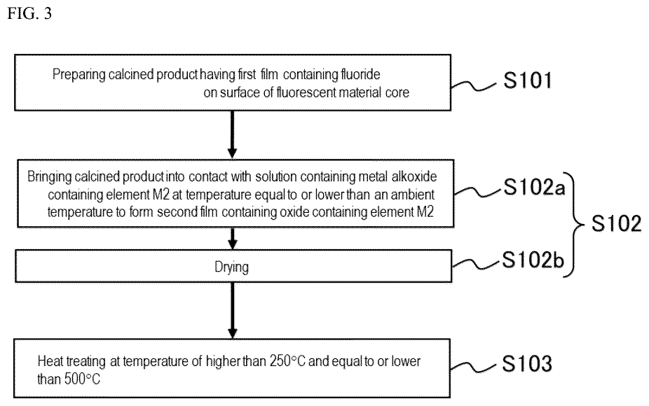

FIG. 3 is a flowchart describing an exemplary method of producing a nitride fluorescent material. The method of producing a nitride fluorescent material shown in FIG. 3 includes forming a second film (S102) that includes bringing a calcined product into contact with a solution containing a metal alkoxide containing an element M2 at a temperature equal to or lower than an ambient temperature to form a second film containing an oxide containing the element M2 (S102a) and drying (S102b). The method of producing a nitride fluorescent material also includes preparing a calcined product including a fluorescent material core and a first film, which contains fluoride, on a surface of the fluorescent material core (S101), and heat-treating at a temperature higher than 250° C. and equal to or lower than 500° C. (S103) in the same manner as in the flowchart of the method of producing a nitride fluorescent material shown in FIG. 1.

The method of producing a nitride fluorescent material preferably includes bringing the calcined product into contact with the solution containing the metal alkoxide two or more times in the forming of the second film. By bringing the calcined product into contact with the solution containing the metal alkoxide two or more times, the covering ratio of the second film is increased, and a denser or thicker second film is formed on the surface of the first film on the fluorescent material core. When a denser or thicker second film is formed on the surface of the first film on the fluorescent material core, the durability of the resulting nitride fluorescent material is further improved. The number of times the calcined product is brought into contact with the solution containing the metal alkoxide may be two or more times, three times or more, and, in consideration of productivity, preferably five times or less. When the calcined product is brought into contact with the solution containing the metal alkoxide two or more times, the temperature to be brought into contact is both at the ambient temperature or lower.

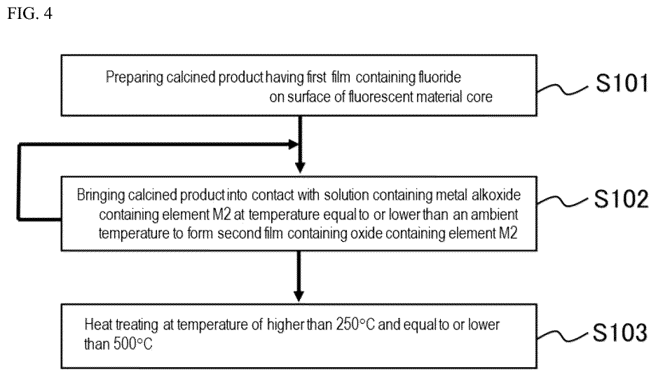

FIG. 4 is a flowchart describing an exemplary method of producing a nitride fluorescent material. The method of producing a nitride fluorescent material shown in FIG. 4 includes bringing a calcined product into contact with a solution containing a metal alkoxide containing an element M2 at a temperature equal to or lower than an ambient temperature to form a second film containing an oxide containing the element M2 (S102) two or more times. The method of producing a nitride fluorescent material also includes preparing a calcined product including a fluorescent material core and a first film, which contains fluoride, on a surface of the fluorescent material core (S101), and heat-treating at a temperature higher than 250° C. and equal to or lower than 500° C. (S103) in the same manner as in the flowchart of the method of producing a nitride fluorescent material shown in FIG. 1.

The method of producing a nitride fluorescent material, when including bringing the calcined product into contact with the solution containing the metal alkoxide and drying, preferably includes bringing the calcined product into contact with the solution containing the metal alkoxide after drying in the forming of the second film. By bringing the calcined product into contact with the solution containing the metal alkoxide, followed by drying, and then bringing the calcined product for the second time into contact with the solution containing the metal alkoxide, the element M2 is bonded in a state containing a hydroxyl group (OH) by contact between the calcined product for the first time and the solution containing the metal alkoxide and drying, and the element M2 is further bonded in a state containing a hydroxyl group (OH) by contact between the calcined product for the second time and the solution containing the metal alkoxide, thereby forming a denser or thicker second film on the surface of the first film on the fluorescent material core. When a denser or thicker second film is formed on the surface of the first film on the fluorescent material core, the durability of the resulting nitride fluorescent material is further improved.

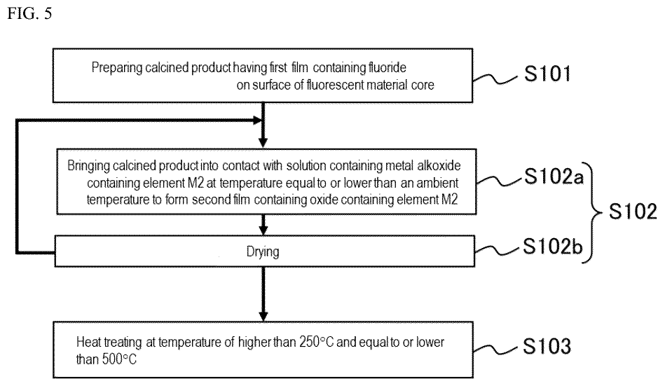

FIG. 5 is a flowchart describing an exemplary method of producing a nitride fluorescent material. The method of producing a nitride fluorescent material shown in FIG. 5 includes forming a second film (S102) that includes bringing a calcined product into contact with a solution containing a metal alkoxide containing an element M2 at a temperature equal to or lower than an ambient temperature to form a second film containing an oxide containing the element M2 (S102a) and drying (S102b), and that includes, after drying, forming a second film (S102a) and drying (S102b) two or more times. The method of producing a nitride fluorescent material also includes preparing a calcined product including a fluorescent material core and a first film, which contains fluoride, on a surface of the fluorescent material core (S101), and heat-treating at a temperature higher than 250° C. and equal to or lower than 500° C. (S103) in the same manner as in the flowchart of the method of producing a nitride fluorescent material shown in FIG. 1.

The method of producing a nitride fluorescent material includes heat-treating the calcined product on which the second film containing the oxide containing the element M2 is formed at a temperature higher than 250° C. and equal to or lower than 500° C. In the method of producing a nitride fluorescent material, when the fluorescent material core is subjected to the first heat treatment at a temperature equal to or higher than 120° C. and equal to or lower than 500° C. in an atmosphere containing a fluorine-containing substance, the heat treatment of the calcined product on which the second film containing the oxide containing the element M2 is formed is also referred to as the second heat treatment. By heat-treating (second heat-treating) the calcined product on which the second film is formed, the dehydration reaction proceeds in the second film containing a hydroxyl group (OH) to form a strong film containing an oxide containing the element M2. The oxygen in the oxide containing the element M2 contained in the second film acts on the first film containing fluoride, and the element M2 may also be contained in the first film. In the nitride fluorescent material obtained after heat-treating (second heat-treating) the calcined product on which the second film is formed, the amount of the element M2 contained in the second film is larger than that of the element M2 contained in the first film. Since the first film also contains the element M2, it is presumed that the fluoride contained in the first film reacts with the oxide containing the element M2 contained in the second film by the second heat treatment whereby the dehydration reaction proceeds in the second film containing a hydroxyl group (OH), and a part of the element M2 (such as Si) contained in the second film is bonded to an element (such as Sr or Al) derived from the fluorescent material core contained in the fluoride in the first film via oxygen, so that the element M2 may also be contained in the first film. In the resulting nitride fluorescent material, the first film and the second film having a large covering ratio function as a double-layer protective film to reduce deterioration of the nitride fluorescent material caused by the external environments, thereby further improving the durability of the resulting nitride fluorescent material. The first film, even when it is integrated with the fluorescent material core after the second heat treatment to be a portion having a fluorine-containing composition that may contain the element M2, protects the nitride fluorescent material from the external environments together with the film containing the oxide containing the element M2, thereby further improving the durability of the nitride fluorescent material.

When the second film containing the oxide containing the element M2 is formed on the calcined product having the first film and heat treatment (second heat treatment) is carried out after forming the second film, oxygen contained in the oxide containing the element M2 in the second film may also act on the first film, so that the second film may also contain fluorine. In the nitride fluorescent material obtained after the second heat treatment, the amount of fluorine contained in the first film is preferably larger than that of fluorine contained in the second film.

The temperature of the heat treatment (second heat treatment) of the calcined product after forming the second film is higher than 250° C. and equal to or lower than 500° C., preferably higher than 250° C. and equal to or lower than 450° C., and more preferably equal to or higher than 300° C. and equal to or lower than 400° C. When the temperature of the heat treatment (second heat treatment) of the calcined product performed after forming the second film is equal to or lower than 250° C., oxygen in the oxide containing the element M2 contained in the second film is less likely to act on the first film due to the low temperature, and the oxide containing the element M2 contained in the second film is less likely to bond to an element derived from the fluorescent material core contained in the first film via oxygen, which reduces the adhesion of the second film and may reduce the function of protecting the fluorescent material core and the first film. When the temperature of the heat treatment (second heat treatment) of the calcined product after forming the second film is higher than 500° C., the crystal structure of the fluorescent material core contained in the calcined product is likely to be broken.

The heat treatment (second heat treatment) of the calcined product after forming the second film is preferably carried out in air or in an inert gas atmosphere. By carrying out the heat treatment (second heat treatment) of the calcined product after forming the second film in air or in an inert gas atmosphere, the dehydration reaction proceeds in the second film containing a hydroxyl group (OH), and a part of the element M2 (such as Si) contained in the second film is firmly bonded to an element (such as Sr or Al) derived from the fluorescent material core contained in the fluoride in the first film via oxygen.

The heat treatment (second heat treatment) of the calcined product after forming the second film can be performed for any appropriate time, and is preferably 1 hour or more and 20 hours or less, more preferably 2 hours or more and 15 hours or less, and even more preferably 3 hours or more and 10 hours or less. When the time of the heat treatment (second heat treatment) of the calcined product after forming the second film is 1 hour or more and 20 hours or less, a second film containing an oxide containing the element M2 with a small amount of hydroxyl group (OH) contained therein can be formed by the heat treatment without affecting the structure of the fluorescent material core.

The method of producing a nitride fluorescent material may include post-treatment, such as crushing treatment, pulverizing treatment, and classifying treatment, for the resulting calcined product or nitride fluorescent material after the first heat treatment and the second heat treatment.

The resulting nitride fluorescent material includes a fluorescent material core having a composition represented by the formula (I), and preferably absorbs light in a range of 400 nm or more and 570 nm or less, which is in the short wavelength region of ultraviolet to visible light, to emit fluorescence having a light emission peak wavelength in a range of 630 nm or more and 670 nm or less. More preferably, the nitride fluorescent material has a light emission spectrum having a light emission peak wavelength in a range of 640 nm or more and 660 nm or less. In addition, the nitride fluorescent material preferably has a light emission spectrum having a full width at half maximum of, for example, 65 nm or less, more preferably 60 nm or less; and preferably 45 nm or more. In the present specification, the full width at half maximum refers to a wavelength width that is 50% of the light emission intensity at the light emission peak wavelength showing the maximum light emission intensity in the light emission spectrum.

The resulting nitride fluorescent material preferably has a median particle diameter Dm, with a cumulative frequency of 50% from the small diameter side in the volume-based particle size distribution measured by the laser diffraction scattering method, in a range of 14 μm or more and 50 μm or less, more preferably in a range of 15 μm or more and 40 μm or less, even more preferably in a range of 15 μm or more and 35 μm or less, and still more preferably in a range of 16 μm or more and 30 μm or less. The nitride fluorescent material obtained by the aforementioned production method has a relatively large median particle diameter Dm since the surface of the fluorescent material core is covered with the first film containing fluoride and the second film containing the oxide containing the element M2. The resulting nitride fluorescent material having a median particle diameter Dm in the range of 14 μm or more and 50 μm or less is protected from the external environments by the first film and the second film, or by the portion having a fluorine-containing composition and the film containing the oxide containing the element M2, thereby reducing deterioration and improving durability. The median particle diameter Dm refers to a median particle diameter (median diameter) with a cumulative frequency of 50% from the small diameter side in the volume-based particle size distribution measured by the laser diffraction scattering method. The median particle diameter Dm can be measured, for example, using a laser diffraction particle size distribution measuring apparatus (Mastersizer 3000, manufactured by Malvern Panalytical Ltd.).

The resulting nitride fluorescent material can be used as a component for wavelength conversion members of light emitting devices.

The nitride fluorescent material includes a fluorescent material core having a composition containing the element M^{a} being at least one element selected from the group consisting of Sr, Ca, Ba, and Mg, the element M^{b} being at least one element selected from the group consisting of Li, Na, and K, the element M^{c} being at least one element selected from the group consisting of Eu, Ce, Tb, and Mn, Al, N, and optionally Si, and a film containing an oxide containing the element M2 being at least one element selected from the group consisting of Si, Al, Ti, Zr, Sn, and Zn arranged on the surface of the fluorescent material core; and has a minimum value of a film thickness ratio Tmin/T in a range of 0.3 or more and 1 or less, wherein the film thickness ratio Tmin/T is a ratio of a minimum film thickness Tmin of the film derived from the following formula (2) to a film thickness T of the film derived from the following formula (1). The nitride fluorescent material is preferably a nitride fluorescent material produced by the aforementioned production method.

Film thickness T=(S2−Sc)/[(P2+Pc)/2] (1)

Minimum film thickness Tmin=(Ss−Sc)/[(Ps+Pc)/2] (2)
wherein, in a scanning electron microscope (SEM) micrograph obtained by photographing the cross-section of the nitride fluorescent material using an SEM, P2 represents an outer circumference length of the film derived from a closed line drawn along the outer circumference of the film to be inscribed on the outer circumference of the film, Pc represents an outer circumference length of the fluorescent material core derived from a closed line drawn along the outer circumference of the fluorescent material core to be inscribed on the outer circumference of the fluorescent material core, Ps represents an outer circumference length of a closed line obtained by enlarging the outer circumference of the fluorescent material core to be inscribed on the outer circumference of the film at the shortest distance from the outer circumference of the fluorescent material core in a direction orthogonal to the outer circumference of the fluorescent material core, S2 represents a cross-sectional area of the fluorescent material core and the film derived from the outer circumference length P2 of the film, Sc represents a cross-sectional area of the fluorescent material core derived from the outer circumference length Pc of the fluorescent material core, and Ss represents a cross-sectional area of the enlarged closed line derived from the outer circumference length Ps. When calculating the thickness of the film of the nitride fluorescent material, it is typically calculated on a cross-section of the nitride fluorescent material through the center or near the center of the fluorescent material.

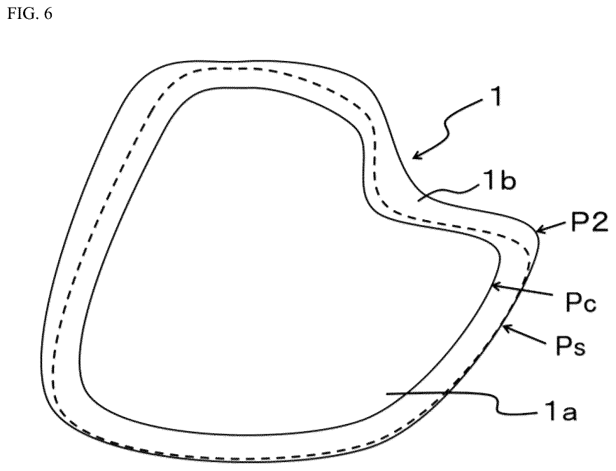

FIG. 6 shows a schematic cross-sectional view of a fluorescent material core and a film.

As shown in the schematic cross-section of a nitride fluorescent material 1, the nitride fluorescent material 1 has irregularities on the surface and is not a perfect circle in the cross-section. The length of a closed line drawn along the outer circumference of a fluorescent material core 1a to be inscribed on the outer circumference of the fluorescent material core 1a is measured as an outer circumference length Pc of the fluorescent material core 1a. A cross-sectional area Sc of the fluorescent material core 1a, when the cross-section of the fluorescent material core 1a is considered as a perfect circle, can be derived from the outer circumference length Pc. The length of a closed line obtained by enlarging the outer circumference of the fluorescent material core 1a to be inscribed on the outer circumference of a film 1b at the shortest distance from the outer circumference of the fluorescent material core 1a in a direction orthogonal to the outer circumference of the fluorescent material core 1a is measured as an outer circumference length Pc. A cross-sectional area Ss of the fluorescent material core 1a and the film 1b having the smallest film thickness, when the cross-section of the fluorescent material core 1a and the film 1b having the smallest film thickness is considered as a perfect circle, can be derived from the outer circumference length Ps. The length of a closed line drawn along the outer circumference of the film 1b to be inscribed on the outer circumference of the film 1b is measured as an outer circumference length P2 of the film 1b. A cross-sectional area S2 of the fluorescent material core 1a and the film 1b, when the outer circumference of the film 1b is considered as a perfect circle, can be derived from the outer circumference length P2 of the film 1b.

In the present specification, the closed line indicating the outer circumference length Pc of the fluorescent material core 1a, the outer circumference length P2 of the film 1b, or the outer circumference length Ps inscribed on the outer circumference of the film 1b at the shortest distance from the outer circumference of the fluorescent material core 1a may be a closed curve or a closed line including a straight line as part of the closed curve.

Specifically, the outer circumference length Pc of the fluorescent material core, the outer circumference length P2 of the film, and the outer circumference length Ps inscribed on the outer circumference of the film at the shortest distance from the outer circumference of the fluorescent material core can be measured from an SEM micrograph of a cross-section of a nitride fluorescent material, which is obtained by using a field emission scanning electron microscope (FE-SEM) after embedding the nitride fluorescent material in a resin, curing the resin, cutting the resin so as to expose the cross-section of the nitride fluorescent material, polishing the surface with sandpaper, and finishing the surface with a cross-section polisher (CP).

When the nitride fluorescent material has a film thickness ratio Tmin/T in a range of 0.3 or more and 1 or less, the fluorescent material core is protected by the film, and the deterioration of the nitride fluorescent material caused by the external environments can be reduced to further improve the durability of the nitride fluorescent material, wherein the film thickness ratio Tmin/T is a ratio of the minimum film thickness Tmin of the film derived from the formula (2) based on the outer circumference length Pc of the fluorescent material core, the cross-sectional area Sc of the fluorescent material core, the outer circumference length Ps inscribed on the outer circumference of the film at the shortest distance from the outer circumference of the fluorescent material core, and the cross-sectional area Ss of the fluorescent material core and the film having the smallest film thickness, to the film thickness T of the film derived from the formula (1) based on the outer circumference length Pc of the fluorescent material core, the cross-sectional area Sc of the fluorescent material core, the outer circumference length P2 of the film, and the cross-sectional area S2 of the fluorescent material core and the film. The film thickness ratio Tmin/T does not exceed 1 and may exceed 0.3.

The arithmetic average value of the film thickness ratio Tmin/T, which is a ratio of the minimum film thickness Tmin of the film derived from the formula (2) to the film thickness T of the film derived from the formula (1), of a predetermined number of the nitride fluorescent materials is preferably in a range of 0.45 or more and 1 or less. In the present specification, the predetermined number of the nitride fluorescent materials for calculating the arithmetic average value is 10. When the arithmetic average value of the film thickness ratio Tmin/T of a predetermined number of the nitride fluorescent materials is in a range of 0.45 or more and 1 or less, in the nitride fluorescent material obtained by the aforementioned production method, the film can sufficiently protect the fluorescent material core, deterioration caused by the external environments can be reduced, and the durability of the nitride fluorescent material can be further improved.

The arithmetic average value of the film thickness T of the film derived from the formula (1) of a predetermined number of the nitride fluorescent materials is preferably in a range of 100 nm or more and 200 nm or less. When the arithmetic average value of the film thickness T of the film of a predetermined number of the nitride fluorescent materials is 100 nm or more and 200 nm or less, the fluorescent material core having a portion having a fluorine-containing composition is sufficiently protected by the film, and the deterioration caused by the external environments can be reduced to improve the durability. The arithmetic average value of the film thickness T of the film of a predetermined number of the nitride fluorescent materials may be in a range of 105 nm or more and 190 nm or less, may be in a range of 110 nm or more and 185 nm or less, or may be in a range of 112 nm or more and 180 nm or less.

The arithmetic average value of the minimum film thickness Tmin of the film derived from the formula (2) of a predetermined number of the nitride fluorescent materials is preferably in a range of 50 nm or more and 100 nm or less. When the arithmetic average value of the minimum film thickness Tmin of the film of a predetermined number of the nitride fluorescent materials is 50 nm or more and 100 nm or less, the fluorescent material core having a portion having a fluorine-containing composition is sufficiently protected by the film even at the minimum film thickness, and the deterioration caused by the external environments can be reduced to improve the durability. The arithmetic average value of the minimum film thickness Tmin of the film of a predetermined number of the nitride fluorescent materials may be in a range of 51 nm or more and 90 nm or less, or may be in a range of 52 nm or more and 80 nm or less.

The standard deviation of the film thickness T of the film derived from the formula (1) of a predetermined number of the nitride fluorescent materials is preferably 25 nm or less. When the standard deviation of the film thickness T of the film of a predetermined number of the nitride fluorescent materials is 25 nm or less, the film thickness variation is small, the fluorescent material core is protected from the external environments by the film, and the deterioration of the nitride fluorescent material can be reduced to improve the durability. The standard deviation of the film thickness T of the film of a predetermined number of the nitride fluorescent materials may be 24 nm or less, or may be 23 nm or less; and may be 1 nm or more, or may be 2 nm or more.

The median value of the film thickness T of the film derived from the formula (1) of a predetermined number of the nitride fluorescent materials is preferably 100 nm or more. The median value of the film thickness T of the film of the nitride fluorescent material is the median of the maximum value and minimum value of the film thickness of the 10 nitride fluorescent materials. When the median value of the film thickness T of the film of a predetermined number of the nitride fluorescent materials is 100 nm or more, a film having a film thickness capable of sufficiently protecting the fluorescent material core can be formed on the surface of the fluorescent material core having a portion having a fluorine-containing composition. The median value of the film thickness T of the film of a predetermined number of the nitride fluorescent materials may be 110 nm or more, or may be 120 nm or more; and may be 200 nm or less, may be 180 nm or less, or may be 150 nm or less.

The minimum value of the film thickness T of the film derived from the formula (1) of a predetermined number of the nitride fluorescent materials is preferably 70 nm or more. When the minimum value of the film thickness T of the film of a predetermined number of the nitride fluorescent materials is 70 nm or more, a film having a film thickness capable of sufficiently protecting the fluorescent material core and having a substantially uniform film thickness can be formed on the surface of the fluorescent material core having a portion having a fluorine-containing composition. The minimum value of the film thickness T of the film of a predetermined number of the nitride fluorescent materials may be 72 nm or more, or may be 74 nm or more; and may be 100 nm or less.

The maximum value of the film thickness T of the film derived from the formula (1) of a predetermined number of the nitride fluorescent materials is preferably 150 nm or less. When the maximum value of the film thickness T of the film of a predetermined number of the nitride fluorescent materials is 150 nm or less, the nitride fluorescent material can absorb light from the light source to emit fluorescence with reduction in a decrease in light emission intensity, even in a state having a film on the surface of the fluorescent material core. The maximum value of the film thickness T of the film of a predetermined number of the nitride fluorescent materials may be 148 nm or less, may be 145 nm or less, or may be 143 nm or less.

The standard deviation of the minimum film thickness Tmin of the film derived from the formula (2) of a predetermined number of the nitride fluorescent materials may be 20 nm or less, or may be 18 nm or less. When the standard deviation of the minimum film thickness Tmin of the film of a predetermined number of the nitride fluorescent materials is 20 nm or less, it may be 0 nm, may be 1 nm or more, may be 2 nm or more, may be 5 nm or more, may be 10 nm or more, or may be 12 nm or more.

The median value of the minimum film thickness Tmin of the film derived from the formula (2) of a predetermined number of the nitride fluorescent materials is preferably 50 nm or more. The median value of the minimum film thickness Tmin of the film of the nitride fluorescent material is the median of the maximum value and minimum value of the minimum film thickness Tmin of the 10 nitride fluorescent materials. When the median value of the minimum film thickness Tmin of the film of a predetermined number of the nitride fluorescent materials is 50 nm or more, a film having a film thickness capable of sufficiently protecting the fluorescent material core can be formed on the surface of the fluorescent material core having a portion having a fluorine-containing composition. The median value of the minimum film thickness Tmin of the film of a predetermined number of the nitride fluorescent materials may be 52 nm or more, may be 55 nm or more, or may be 57 nm or more; and may be 90 nm or less, or may be 80 nm or less.

The minimum value of the minimum film thickness Tmin of the film derived from the formula (2) of a predetermined number of the nitride fluorescent materials is preferably 22 nm or more. When the minimum value of the minimum film thickness Tmin of the film of a predetermined number of the nitride fluorescent materials is 20 nm or more, a film having a film thickness capable of sufficiently protecting the fluorescent material core and having a substantially uniform film thickness can be formed on the surface of the fluorescent material core having a portion having a fluorine-containing composition. The minimum value of the minimum film thickness Tmin of the film of a predetermined number of the nitride fluorescent materials may be 23 nm or more, or may be 24 nm or more; and may be 40 nm or less.

The maximum value of the minimum film thickness Tmin of the film derived from the formula (2) of a predetermined number of the nitride fluorescent materials may be 100 nm or less, or may be 90 nm or less. When the fluorescent material core has a film having a more uniform film thickness on the surface, the maximum value of the minimum film thickness Tmin is preferably 60 nm or more, may be 70 nm or more, or may be 75 nm or more.

The nitride fluorescent material produced by the aforementioned production method, which is a nitride fluorescent material having a minimum value of the film thickness ratio Tmin/T in the range of 0.3 or more and 1 or less, can be used as a component for wavelength conversion members of light emitting devices.

The light emitting device includes an excitation light source that emits light having a wavelength in a range of 400 nm or more and 570 nm or less. A light emitting element can be used as the excitation light source for the light emitting device. The light emitting element preferably has a light emission peak wavelength in a range of 400 nm or more and 570 nm or less, more preferably in a range of 420 nm or more and 500 nm or less, and even more preferably in a range of 420 nm or more and 460 nm or less. By using a light emitting element having a light emission peak wavelength in the range of 400 nm or more and 570 nm or less as the excitation light source, a light emitting device capable of emitting mixed-color light of light from the light emitting element and fluorescence from the fluorescent material can be formed.

For the light emitting element, a semiconductor light emitting element using a nitride-based semiconductor (In_{X}Al_{Y}Ga_{1-X-Y}N, 0≤X, 0≤Y, X+Y≤1) is preferably used. By using a semiconductor light emitting element as the excitation light source for the light emitting device, a stable light emitting device having high efficiency, high output linearity with respect to the input, and high resistance to mechanical impacts can be obtained. The light emitting element preferably has a light emission spectrum with a full width at half maximum of, for example, 30 nm or less.

The light emitting device may include a nitride fluorescent material produced by the aforementioned production method, which is a nitride fluorescent material having a minimum value of the film thickness ratio Tmin/T in the range of 0.3 or more and 1 or less. The nitride fluorescent material preferably has a fluorescent material core having a composition represented by the formula (I) and is excited by light in a wavelength range of 400 nm or more and 570 nm or less to emit fluorescence having a light emission peak wavelength in a range of 630 nm or more and 670 nm or less. The light emitting device may include a first fluorescent material containing a nitride fluorescent material and a second fluorescent material having a composition different from that of the nitride fluorescent material and emitting fluorescence having a light emission peak wavelength different from that of the first fluorescent material.

The first fluorescent material may be contained, for example, in a wavelength conversion member covering an excitation light source to form a light emitting device. The light emitting device having an excitation light source covered with a wavelength conversion member containing the first fluorescent material absorbs a part of light emitted from the excitation light source by the first fluorescent material and emits light as red light. By using an excitation light source that emits light in a wavelength range of 400 nm or more and 570 nm or less, the emitted light can be used more effectively.

Any appropriate content of the first fluorescent material can be contained in the light emitting device. For example, the content of the first fluorescent material may be in a range of 1 part by mass or more and 200 parts by mass or less relative to 100 parts by mass of a resin constituting the wavelength conversion member, and is preferably in a range of 2 parts by mass or more and 180 parts by mass or less.

The first fluorescent material and/or the second florescent material (hereinafter simply referred to as “fluorescent material”) may constitute the wavelength conversion member covering the light emitting element together with a resin. Examples of the resin constituting the wavelength conversion member include a silicone resin and an epoxy resin.

The wavelength conversion member may further contain a filler, a light diffusing material, or other materials in addition to the resin and the fluorescent material. By containing, for example, a light diffusing material, the directivity of the light emitting element can be relaxed to increase the viewing angle. Examples of the filler include silica, titanium oxide, zinc oxide, zirconium oxide, and alumina. When the wavelength conversion member contains a filler, the content thereof can be selected appropriately according to the purpose. The content of the filler may be, for example, in a range of 1% by mass or more and 20% by mass or less relative to the resin.

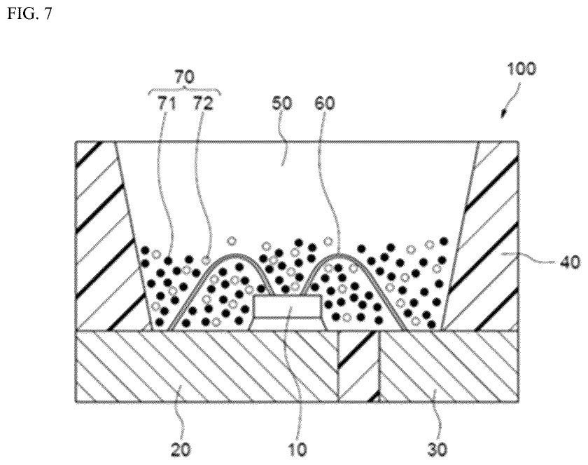

FIG. 7 is a schematic cross-sectional view showing an example of the light emitting device.

A light emitting device 100 is provided with a package having a recessed portion formed by lead electrodes 20 and 30 and a molded body 40, a light emitting element 10, and a wavelength conversion member 50 that covers the light emitting element 10. The light emitting element 10 is arranged inside the recessed portion of the package, and is electrically connected to the pair of positive and negative lead electrodes 20 and 30 provided on the molded body 40 via a conductive wire 60. The wavelength conversion member 50 is filled in the recessed portion of the package to cover the light emitting element 10, and seals the recessed portion of the package. The wavelength conversion member 50 contains, for example, a florescent material 70 that converts the wavelength of light emitted from the light emitting element 10, and a resin. The fluorescent material 70 includes a first fluorescent material 71 and a second fluorescent material 72. A portion of the pair of positive and negative lead electrodes 20 and 30 is exposed on the outer surface of the package. The light emitting device 100 emits light by receiving electric power supplied from the outside through these lead electrodes 20 and 30.

The wavelength conversion member 50 contains the resin and the fluorescent material, and is formed to cover the light emitting element 10 arranged inside the recessed portion of the light emitting device 100.

Embodiments according to the present disclosure include the following methods for producing a nitride fluorescent material and the nitride fluorescent materials.

### EXAMPLES

The present disclosure is hereunder specifically described by reference to the following Examples.

The present disclosure is not limited to these Examples.

### Production of Fluorescent Material Core

A fluorescent material core having a composition containing Sr, Li, Eu, Al, and N was produced. Specifically, for producing a fluorescent material core having a composition represented by the formula (I) of M^{a}ᵥM^{b}_{w}M^{c}ₓAl_{3-y}Si_{y}N_{z}, Sr₃N₂, LINH₂, AlN, and EuHₜ (wherein t represents the absolute value of an electric charge of Eu ion) were used as raw materials such that M^{a} was Sr, M^{b} was Li, and M^{c} was Eu. In Examples, the parameter y in the formula (I) is 0, and the fluorescent material core does not contain Si. The aforementioned raw materials were weighed in a glove box in an inert gas atmosphere such that a molar ratio thereof as a charged amount ratio was Sr:Li:Eu:Al=1.191:1.175:0.0075:3.0000, LiF as a flux was further added thereto in an amount of 5% by mass relative to 100% by mass of the total amount of the aforementioned raw materials, and these were mixed to obtain a raw material mixture. The raw material mixture was filled into a crucible and heat-treated at a temperature of 1,050° C. for 3 hours in a nitrogen gas atmosphere at a gas pressure of 0.92 MPa (1.02 MPa in absolute pressure) as a gauge pressure.

After the heat treatment, the resulting product was dispersed and classified to obtain a fluorescent material core having a composition represented by SrᵥLi_{w}EuₓAl₃N_{z}. For the parameters v, w, x, and z in the composition represented by SrᵥLi_{w}EuₓAl₃N_{z}, for example, v was 1.02, w was 1.19, x was 0.007, and z satisfied 1.5≤z≤5.0. The fluorescent material core was brought into contact with an acidic solution of pH 3 containing hydrochloric acid at 20° C. to 22° C. for 60 minutes prior to a first heat treatment.

### Example 1

### Preparing of Calcined Product

The fluorescent material core was subjected to a first heat treatment at a temperature of 200° C. for a treatment time of 8 hours in an atmosphere containing a fluorine gas (F₂) and a nitrogen gas (N₂) and having a fluorine gas concentration of 20% by volume and a nitrogen gas concentration of 80% by volume to obtain a calcined product having a first film containing fluoride on the surface of the fluorescent material core.

### Forming of Second Film

A reaction solution was prepared by mixing 180 mL of ethanol, 43.4 mL of ammonia water containing 16.5% by mass of ammonia as a basic catalyst, and 20 mL of pure water. The pH of the reaction solution was 14. Into the reaction solution, 100 g of the calcined product having a first film containing fluoride on the surface of the fluorescent material core was added and stirred, and the temperature of the reaction solution was maintained at 20° C. to 22° C. The ambient temperature was 20° C. to 22° C., and the temperature of the reaction solution was maintained at the ambient temperature or lower. Tetraethoxysilane (Si(OC₂H₅)₄) in an amount of 34.7 g was used as a solution containing a metal alkoxide. In the solution containing a metal alkoxide, the element M2 is Si, and the solution containing a metal alkoxide contains tetraethoxysilane with 10% by mass of SiO₂ relative to 100% by mass of the calcined product. The solution containing a metal alkoxide was added dropwise to the reaction solution over 150 minutes while stirring the reaction solution. After the dropwise addition of the solution containing a metal alkoxide was completed, the reaction solution was stirred for 60 minutes while maintaining the temperature of the reaction solution at 20° C. to 22° C., which is the ambient temperature or lower, to bring the calcined product into contact with the solution containing a metal alkoxide in the presence of ammonia as a basic catalyst and in the absence of M1 ions. The stirring was then stopped, and the calcined product having a second film containing Si-containing oxide (SiO₂) formed thereon was taken out of the reaction solution and dried at 105° C. for 3 hours in an explosion-proof dryer (manufactured by Daido Industries, Inc.) to obtain a calcined product having a second film formed thereon.

### Heat Treating

The calcined product having a second film formed thereon was subjected to a heat treatment (second heat treatment) at a temperature of 400° C. for a treatment time of 10 hours in air to obtain a nitride fluorescent material of Example 1. The nitride fluorescent material of Example 1 had a fluorescent material core, a first film containing fluoride, and a second film containing silicon dioxide (SiO₂).

### Example 2

A nitride fluorescent material of Example 2 was obtained in the same manner as in Example 1, except that in the forming of the second film in Example 1, a solution containing tetraethoxysilane (Si(OC₂H₅)₄) with 5% by mass of SiO₂ relative to 100% by mass of the calcined product having a first film containing fluoride on the surface of the fluorescent material core as in Example 1 was used, the calcined product was brought into contact with a solution containing a metal alkoxide in the same manner as in Example 1 and then dried, and after drying, the calcined product was brought into contact with the solution containing the metal alkoxide with 5% by mass of SiO₂ relative to 100% by mass of the calcined product a second time in the same manner as in Example 1 and then dried a second time. The nitride fluorescent material of Example 2 had a fluorescent material core, a first film containing fluoride, and a second film containing silicon dioxide (SiO₂).

### Example 3

A nitride fluorescent material of Example 3 was obtained in the same manner as in Example 2, except that in the forming of the second film in Example 1, the temperature of the reaction solution was maintained at 5° C. In Example 3, the ambient temperature was 20° C. to 22° C. The nitride fluorescent material of Example 3 had a fluorescent material core, a first film containing fluoride, and a second film containing silicon dioxide (SiO₂).

### Example 4

In the forming of the second film in Example 1, a reaction solution was prepared by mixing 20 mL of a saturated aqueous solution of SrO as a compound containing the element M1, instead of pure water. The pH of the reaction solution was 14. A nitride fluorescent material of Example 4 was obtained in the same manner as in Example 3, except that this reaction solution was used. The nitride fluorescent material of Example 4 had a fluorescent material core, a first film containing fluoride, and a second film containing silicon dioxide (SiO₂).

### Comparative Example 1

In the forming of the second film in Example 1, a reaction solution was prepared by mixing 180 mL of ethanol and 14.6 mL of ammonia water containing 16.5% by mass of ammonia as a basic catalyst. The pH of the reaction solution was 14. Into the reaction solution, 100 g of the calcined product having a first film containing fluoride on the surface of the fluorescent material core was added and stirred, and the temperature of the reaction solution was maintained at 50° C. The ambient temperature was 20° C. to 22° C. Tetraethoxysilane (Si(OC₂H₅)₄) in an amount of 34.7 g was used as a liquid A, and a mixture of 29 ml of ammonia water containing 16.5% by mass of ammonia and 20 ml of pure water was used as a liquid B. In the solution containing a metal alkoxide, the element M2 is Si, and the solution containing a metal alkoxide contains tetraethoxysilane (Si(OC₂H₅)₄) with 10% by mass of SiO₂ relative to 100% by mass of the calcined product. The liquid A and the liquid B were added dropwise to the reaction solution over 150 minutes while stirring the reaction solution. A nitride fluorescent material of Comparative Example 1 was obtained in the same manner as in Example 1, except that after the dropwise addition, the reaction solution was stirred for 60 minutes while maintaining the temperature of the reaction solution at 50° C. to bring the calcined product into contact with the solution containing a metal alkoxide in the presence of ammonia as a basic catalyst, the stirring was then stopped, and the calcined product having a second film containing Si-containing oxide (SiO₂) formed thereon was taken out of the reaction solution and dried at 105° C. for 3 hours in an explosion-proof dryer (manufactured by Daido Industries, Inc.) to obtain a calcined product having a second film formed thereon. The nitride fluorescent material of Comparative Example 1 had a fluorescent material core, a first film containing fluoride, and a second film containing silicon dioxide (SiO₂).

The nitride fluorescent materials obtained by the production methods of Examples and Comparative Example were evaluated as follows. The results are shown in Table 1. In Table 1, the symbol “-” indicates that there is no corresponding item.

### Light Emission Characteristics

Each nitride fluorescent material was irradiated with excitation light having a light emission peak wavelength of 450 nm to measure the light emission spectrum using a fluorospectrophotometer (QE-2000, manufactured by Otsuka Electronics Co., Ltd.), and the chromaticity coordinates (x, y) in the chromaticity coordinate system of the CIE (Commission Internationale de l'Eclairage) 1931 chromaticity diagram were measured from the light emission spectrum.

### Median Particle Diameter Dm and Standard Deviation

For each nitride fluorescent material, the median particle diameter (median diameter) Dm with a cumulative frequency of 50% from the small diameter side and the standard deviation (σ log) in a volume-based particle size distribution were measured by a laser diffraction scattering method using a laser diffraction scattering particle size distribution measuring apparatus (Mastersizer 3000, manufactured by Malvern Panalytical Ltd.).

### Compositional Analysis

Each nitride fluorescent material obtained was subjected to compositional analysis by ICP light emission spectrometry using an inductively coupled plasma atomic emission spectrometer. Silicon (Si) was calculated as the content of SiO₂ in the second film when the results obtained from the compositional analysis were converted to oxide-equivalent data and the nitride fluorescent material was 100% by mass. Fluorine was quantitatively analyzed by a UV-VIS method using a double-beam spectrophotometer (U-2900, manufactured by Hitachi High-Technologies Corp.).

### Coating Ratio

The calcined product and the nitride fluorescent material obtained in each of Examples and Comparative Example were subjected to X-ray fluorescence spectrometry (XRF) using an XRF apparatus (ZSX Primus II, manufactured by Rigaku Corp.) to measure the peak intensity of the Kα ray of the Sr element or the Kα ray of the Al element. For each nitride fluorescent material obtained, an arbitrary cross-section was observed using a scanning electron microscope (SEM) to confirm the presence or absence of an oxide film by image analysis. Specifically, a plurality of nitride fluorescent material particles were embedded in a resin, and a cross-sectional sample was prepared by an ion milling process to enable cross-sectional observation of the nitride fluorescent material particles by a scanning electron microscope, and to confirm the presence of a second film containing an oxide having a certain thickness or more. The relative intensity RI₀ was then calculated from the peak intensity of the Kα ray of the Al element relative to the peak intensity of the Kα ray of the Sr element in the calcined product having a covering ratio of 0% by the method described above, according to the formula (3). The relative intensity RI of the peak intensity of the Kα ray of the Al element relative to the peak intensity of the Kα ray of the Sr element in the nitride fluorescent material on which the second film containing an oxide was formed was calculated according to the formula (4). The highest relative intensity RI among the relative intensities RI of a plurality of nitride fluorescent materials was denoted as the relative intensity RI₁₀₀ of the nitride fluorescent material having the second film containing an oxide with a covering ratio of 100%, as shown in the formula (4′). Among the nitride fluorescent materials obtained by the production methods according to Examples 1 to 4, the nitride fluorescent material obtained by the production method according to Example 3 had the highest value of the relative intensity RI. Therefore, the relative intensity RI of the nitride fluorescent material obtained by the production method according to Example 3 was used as the relative intensity RI₁₀₀, the relative intensity RI₀ and the relative intensity RI₁₀₀ were plotted on a graph having the relative intensity RI on the horizontal axis and the covering ratio (%) on the vertical axis, and a straight line connecting these points was drawn. The relative intensity RI of the nitride fluorescent material obtained by the production method according to each of Examples and Comparative Example was calculated according to the formula (4), and the covering ratio (%) of each nitride fluorescent material was derived from the point where the relative intensity RI of each nitride fluorescent material and the straight line from RI₀ to RI₁₀₀ intersect.

Since the peak intensity of the Kα ray of the Al element in the nitride fluorescent material obtained in each of Examples and Comparative Example is affected by the shielding effect of the Si element contained in the second film, the detection amount is weakened as the covering ratio increases. Therefore, the covering ratio can be derived from the relative intensity RI₀ of the peak intensity of the Kα ray of the Al element relative to the peak intensity of the Kα ray of the Sr element in the calcined product, from the relative intensity RI of the peak intensity of the Kα ray of the Al element relative to the peak intensity of the Kα ray of the Sr element in the nitride fluorescent material, and from the maximum value RI₁₀₀ of the relative intensity RI of the peak intensity of the Kα ray of the Al element relative to the peak intensity of the Kα ray of the Sr element in the nitride fluorescent material. Since the peak intensity of the Kα line of the Al element is affected by the shielding effect of the Si element contained in the second film as the covering ratio increases, the larger the value of the relative intensity RI, the lower the covering ratio becomes, resulting in a straight line that slopes to the right, when the horizontal axis is the relative intensity RI and the vertical axis is the covering ratio in the graph.

To derive the covering ratio, the relative intensity can also be calculated from the peak intensity of the Lα ray of the Sr element in addition to the peak intensity of the Kα ray of the Sr element and the peak intensity of the Kα ray of the Al element in the calcined product. The relative intensity can also be calculated from the peak intensity of the Lα ray of the Sr element in addition to the peak intensity of the Kα ray of the Sr element and the peak intensity of the Kα ray of the Al element in the nitride fluorescent material.

### Durability Evaluations (Chromaticity Change Δx, Light Emission Intensity Maintenance Ratio (%), Mass Increase Ratio (%))

Each nitride fluorescent material was placed in a transparent container, and the container was placed in an environmental tester with a temperature of 130° C. and a relative humidity of 100% and stored for 30 hours for a durability test (pressure cooker test). Each nitride fluorescent material after the durability test was irradiated with excitation light having a light emission peak wavelength of 450 nm to measure the light emission spectrum using a fluorospectrophotometer (QE-2000, manufactured by Otsuka Electronics Co., Ltd.), and the chromaticity coordinates (x, y) in the chromaticity coordinate system of the CIE 1931 chromaticity diagram were measured from the light emission spectrum. The x value in the chromaticity coordinates of the nitride fluorescent material before the durability test was denoted as the initial value, and the absolute value of the difference between the initial value and the x value of the nitride fluorescent material after the durability test was determined as the chromaticity change Δx. The ratio of the light emission intensity expressed by the area surrounded by the light emission spectrum of each nitride fluorescent material after the durability test and the horizontal axis of the width of the wavelength where the vertical axis becomes 0, to the 100% of the light emission intensity expressed by the area surrounded by the light emission spectrum of each nitride fluorescent material before the durability test and the horizontal axis of the width of the wavelength where the vertical axis becomes 0, was determined as the light emission intensity maintenance ratio (%). The increase ratio of the mass (g) of each nitride fluorescent material after the durability test to 100% of the mass (g) of each nitride fluorescent material before the durability test was determined as the mass increase ratio (%). An increase in the mass of the nitride fluorescent material indicates that impurities are adhering to the surface of the nitride fluorescent material, and a higher mass increase ratio indicates that the nitride fluorescent material is deteriorating.

### Photograph

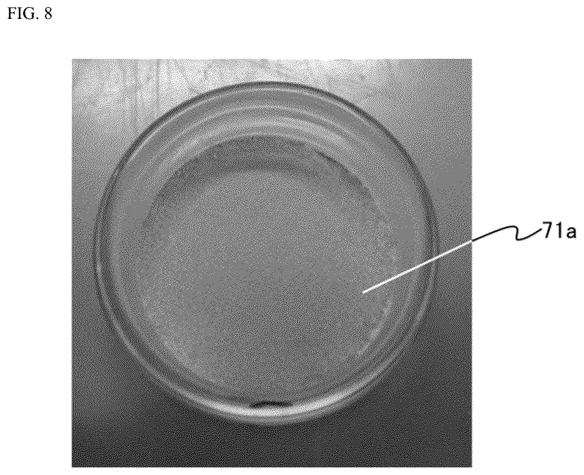

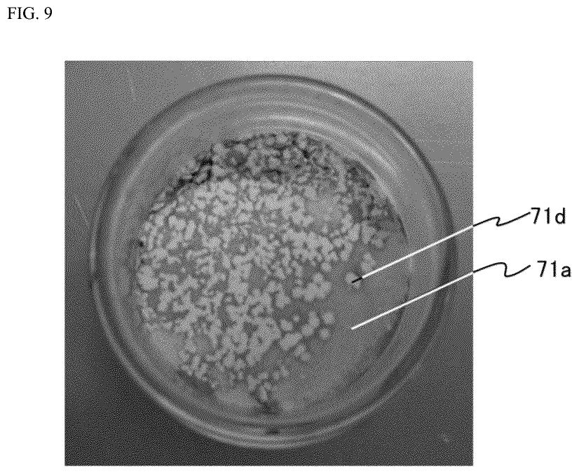

The appearance photograph of the nitride fluorescent material according to Example 1 after the durability test (FIG. 8) and the appearance photograph of the nitride fluorescent material according to Comparative Example 1 after the durability test (FIG. 9) were photographed.

TABLE 1

| | Forming conditions of second film | | | | | | | | | |
|---|---|---|---|---|---|---|---|---|---|---|
| | Content of | | | | | | | | | Nitride |
| | oxide (SiO₂) | | | | | | | | | fluorescent |
| | containing | | | | | | | | | material |
| | element M2 | | | | | | | | | Center |
| | in solution | | Reaction | | | Heat treatment conditions | | | | particle |
| | containing | | solution | | | (second heat treatment) | | | | diameter |
| | metal alkoxide | Number of | temperature | Basic catalyst | | | Temp. | Time | Element | Dm |
| | (% by mass) | contacts | (° C.) | Type | Addition | Atmos. | (° C.) | (H) | M1 | (μm) |
| Example 1 | 10 | 1 | 20-22 | NH₃ | reaction | Air | 400 | 10 | — | 17.4 |
| | | | | | solution | | | | | |
| Example 2 | 5 | 2 | 20-22 | NH₃ | reaction | | | | — | 17.0 |
| | | | | | solution | | | | | |
| Example 3 | 5 | 2 | 5 | NH₃ | reaction | | | | — | 25.7 |
| | | | | | solution | | | | | |
| Example 4 | 5 | 2 | 5 | NH₃ | reaction | | | | Sr | 25.2 |
| | | | | | solution | | | | | |
| Comparative | 10 | 1 | 50 | NH₃ | solution | | | | — | 13.2 |
| Example 1 | | | | | containing | | | | | |
| | | | | | metal | | | | | |
| | | | | | alkoxide | | | | | |

| | Nitride fluorescent material | | | | | | Durability evaluations | | |
|---|---|---|---|---|---|---|---|---|---|
| | | | | Compositional | | | | Light | |
| | | | | analysis | | Covering | | emission | |
| | | | | (ICP measurement) | | ratio | | intensity | Mass |
| | Standard | Chromaticity | | F | SiO₂ | (XRF | Chromaticity | maintenance | increase |
| | deviation | coordinates | | (% by | (% by | analysis) | change | ratio | ratio |
| | αlog | x | y | mass) | mass) | (%) | Δx | (%) | (%) |
| Example 1 | 0.489 | 0.709 | 0.290 | 4.2 | 8.8 | 79.6 | 0.014 | 68 | 126.2 |
| Example 2 | 0.465 | 0.707 | 0.292 | 4.2 | 9.0 | 90.6 | 0.014 | 64 | 128.5 |
| Example 3 | 0.304 | 0.705 | 0.294 | 4.2 | 9.0 | 100.0 | 0.011 | 71 | 123.7 |
| Example 4 | 0.311 | 0.704 | 0.295 | 4.2 | 9.4 | 98.4 | 0.009 | 74 | 123.9 |
| Comparative | 0.380 | 0.706 | 0.294 | 4.2 | 9.0 | 71.5 | 0.006 | 75 | 131.4 |
| Example 1 | | | | | | | | | |

In the nitride fluorescent materials obtained by the production methods according to Examples 1 to 4, the calcined product having the first film containing fluoride on the surface was brought into contact with the solution containing the metal alkoxide at a temperature equal to or lower than an ambient temperature. Therefore, the covering ratio of the second film containing SiO₂, which is an oxide containing the element M2, was large, and the median particle diameter Dm of the obtained nitride fluorescent materials was larger than that of the nitride fluorescent material obtained by the production method according to Comparative Examples 1.

The nitride fluorescent materials obtained by the production methods according to Examples 1 to 4 exhibited a chromaticity change Δx reduced to 0.015 or less after the durability test at a temperature of 130° C. and a relative humidity of 100% for 30 hours.

The nitride fluorescent materials obtained by the production methods according to Examples 1 to 4 had a light emission intensity maintenance ratio of 60% or more even after the durability test, indicating that the deterioration caused by the external environments was reduced.

The nitride fluorescent materials obtained by the production methods according to Examples 1 to 4 had a mass increase ratio smaller than that of Comparative Example 1 even after the durability test, and the mass increase ratio indicating deterioration due to impurity adhesion was reduced.

In the nitride fluorescent materials obtained by the production methods according to Examples 3 to 4, the calcined product was brought into contact with the solution containing the metal alkoxide at a low temperature of 5° C., which is 10° C. or more lower than the ambient temperature. Therefore, it is presumed that the reaction proceeded relatively slowly, and the covering ratio of the film containing the oxide containing the element M2 increased. The nitride fluorescent materials obtained by the production methods according to Examples 3 to 4 had smaller chromaticity change Δx values, further reduced deterioration, and better durability than those of the nitride fluorescent materials obtained by the production methods according to Examples 1 to 2.

The nitride fluorescent material obtained by the production method according to Comparative Example 1 had a small median particle diameter Dm of less than 14 μm, and the covering ratio of the second film containing the oxide in the nitride fluorescent material was small at 71.5%. The nitride fluorescent material obtained by the production method according to Comparative Example 1 had a large mass increase ratio indicating deterioration due to impurity adhesion.

FIG. 8 shows an appearance photograph of a nitride fluorescent material 71a obtained by the production method according to Example 4 after the durability test. The nitride fluorescent material 71a obtained by the production method according to Example 4 had no change in appearance even after the durability test and had improved durability.

FIG. 9 shows an appearance photograph of a nitride fluorescent material 71a obtained by the production method according to Comparative Example 1 after the durability test. The nitride fluorescent material 71a obtained by the production method according to Comparative Example 1 had white portions 71d after the durability test, indicating that the nitride fluorescent material was deteriorated. Since the nitride fluorescent material obtained by the production method according to Comparative Example 1 was partially deteriorated, the chromaticity change Δx and the light emission intensity maintenance ratio could not be measured after the durability test.

### SEM Micrograph—Reflected Electron Image

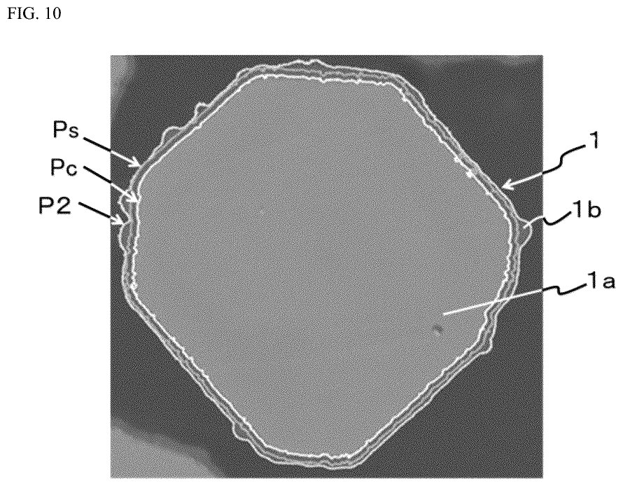

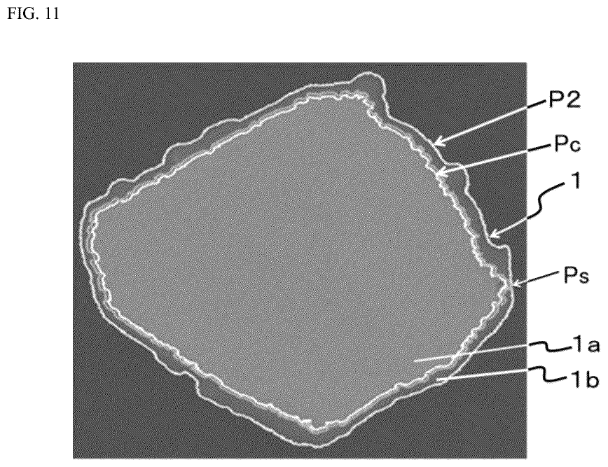

The resulting nitride fluorescent material according to each of Examples 1 and 3 and Comparative Example 1 was embedded in an epoxy resin, the resin was cured, and the resin was then cut to expose the cross-section of the nitride fluorescent material. The surface was polished with sandpaper and then finished with a cross-section polisher (CP). Using a field emission scanning electron microscope (FE-SEM, product name: JSM-7800F, manufactured by JEOL Ltd.), an SEM micrograph of the reflected electron image of the cross-section of the nitride fluorescent material according to each of Examples 1 and 3 and Comparative Example 1 was obtained. FIG. 10 shows an SEM micrograph of the reflected electron image of the cross-section of the nitride fluorescent material according to Example 3. FIG. 11 shows an SEM micrograph of the reflected electron image of the cross-section of the nitride fluorescent material according to Comparative Example 1.

From the obtained SEM micrograph of the reflected electron image, for 10 each of the nitride fluorescent materials according to Examples 1 and 3 and Comparative Example 1, the outer circumference length P2 of the film derived from a closed line drawn along the outer circumference of the film to be inscribed on the outer circumference of the film, the outer circumference length Pc of the fluorescent material core derived from a closed line drawn along the outer circumference of the fluorescent material core to be inscribed on the outer circumference of the fluorescent material core, and the outer circumference length Ps of a closed line obtained by enlarging the outer circumference of the fluorescent material core to be inscribed on the outer circumference of the film at the shortest distance from the outer circumference of the fluorescent material core in a direction orthogonal to the outer circumference of the fluorescent material core, were measured. The cross-sectional area S2 of the fluorescent material core and the film, when the outer circumference of the film is considered as a perfect circle, was derived from the outer circumference length P2 of the film; the cross-sectional area Sc of the fluorescent material core, when the cross-section of the fluorescent material core is considered as a perfect circle, was derived from the outer circumference length Pc of the fluorescent material core; and the cross-sectional area Ss of the fluorescent material core and the film having the smallest film thickness, when the cross-section of the fluorescent material core and the film having the smallest film thickness is considered as a perfect circle, was derived from the outer circumference length Ps. The film thickness T of the film of the nitride fluorescent material was calculated from the following formula (1). The minimum film thickness Tmin of the film of the nitride fluorescent material was calculated from the following formula (2).

Film thickness T=(S2−Sc)/[(P2+Pc)/2] (1)

Minimum film thickness Tmin=(Ss−Sc)/[(Ps+Pc)/2] (2)

The film thickness T and the minimum film thickness Tmin were measured for 10 each of the nitride fluorescent materials according to Examples 1 and 3 and Comparative Example 1 to determine the arithmetic average value, minimum value, maximum value, standard deviation, and median value of the film thickness T and median value of the minimum film thickness Tmin of the film of the 10 nitride fluorescent materials. In addition, the film thickness ratio Tmin/T of the minimum film thickness Tmin to the film thickness T of the film of the nitride fluorescent materials was calculated to determine the arithmetic average value, minimum value, maximum value, standard deviation, and median value of the film thickness ratio Tmin/T. The results are shown in Table 2.

TABLE 2

| | | Average | Minimum | Maximum | Standard | Median |
|---|---|---|---|---|---|---|
| | | value | value | value | deviation | Value |
| Example 1 | Film thickness T (nm) | 113.7 | 74.3 | 140.6 | 22.2 | 120.3 |
| | Minimum film thickness | 53.3 | 24.8 | 79.3 | 17.6 | 58.7 |
| | Tmin (nm) | | | | | |
| | Film thickness ratio | 0.461 | 0.303 | 0.641 | 0.107 | 0.470 |
| | Tmin/T | | | | | |
| Example 3 | Film thickness T (nm) | 118.6 | 84.1 | 137.5 | 18.7 | 123.5 |
| | Minimum film thickness | 60.1 | 30.6 | 85.2 | 14.0 | 61.6 |
| | Tmin (nm) | | | | | |
| | Film thickness ratio | 0.503 | 0.364 | 0.619 | 0.075 | 0.501 |
| | Tmin/T | | | | | |
| Comparative | Film thickness T (nm) | 97.4 | 67.9 | 152.1 | 26.5 | 92.8 |
| Example 1 | Minimum film thickness | 34.7 | 21.4 | 54.5 | 11.6 | 33.8 |
| | Tmin (nm) | | | | | |
| | Film thickness ratio | 0.364 | 0.223 | 0.559 | 0.106 | 0.366 |
| | Tmin/T | | | | | |

In the nitride fluorescent materials according to Examples 1 and 3, the minimum value of the film thickness ratio Tmin/T of the film was in the range of 0.3 or more and 1 or less. In the nitride fluorescent materials according to Examples 1 and 3, the arithmetic average value of the film thickness ratio Tmin/T of the film of the 10 nitride fluorescent materials was in the range of 0.45 or more and 1 or less. In the nitride fluorescent materials according to Examples 1 and 3, the arithmetic average value of the film thickness T of the film of the 10 nitride fluorescent materials was in the range of 100 nm or more and 200 nm or less. In the nitride fluorescent materials according to Examples 1 and 3, the arithmetic average value of the minimum film thickness Tmin of the film of the 10 nitride fluorescent materials was in the range of 50 nm or more and 100 nm or less. In the nitride fluorescent materials according to Examples 1 and 3, the standard deviation of the film thickness T of the film of the 10 nitride fluorescent materials was 25 nm or less. In the nitride fluorescent materials according to Examples 1 and 3, the median value of the film thickness T of the film of the 10 nitride fluorescent materials was 100 nm or more. In Examples 1 and 3, the film containing SiO₂, which is an oxide containing the element M2, sufficiently protected the fluorescent material core, and as shown in the durability test described above, the deterioration of the nitride fluorescent material caused by external environments was reduced to improve the durability of the nitride fluorescent material.

In the nitride fluorescent material according to Comparative Example 1, the minimum value of the film thickness ratio Tmin/T of the film was less than 0.3. In the nitride fluorescent material according to Comparative Example 1, the arithmetic average value of the film thickness ratio Tmin/T of the film of the 10 nitride fluorescent materials was less than 0.45. In the nitride fluorescent material according to Comparative Example 1, the arithmetic average value of the film thickness T of the film of the 10 nitride fluorescent materials was less than 100 nm. In the nitride fluorescent material according to Comparative Example 1, the arithmetic average value of the minimum film thickness Tmin of the film of the 10 nitride fluorescent materials was less than 50 nm. In the nitride fluorescent material according to Comparative Example 1, the standard deviation of the film thickness T of the film of the 10 nitride fluorescent materials was more than 25 nm. In the nitride fluorescent material according to Comparative Example 1, the median value of the film thickness T of the film of the 10 nitride fluorescent materials was less than 100 nm. As described above, the nitride fluorescent material according to Comparative Example 1 had a large mass increase rate indicating deterioration due to impurity adhesion, which resulted in the deterioration of the nitride fluorescent material caused by the external environments not being reduced.

As shown in FIG. 10, the nitride fluorescent material according to Example 3 had a film having a film thickness sufficient to protect the fluorescent material core from the external environments and having a substantially uniform film thickness, formed on the surface of the fluorescent material core.

As shown in FIG. 11, the nitride fluorescent material according to Comparative Example 1 had a film having a non-uniform film thickness formed on the surface of the fluorescent material core.

The nitride fluorescent material obtained by the method of producing a nitride fluorescent material of the present disclosure can be used as a fluorescent material contained in wavelength conversion members of light emitting devices, and light emitting devices containing the nitride fluorescent material can be suitably used for applications such as illumination light sources, LED displays, backlight sources for liquid crystals, traffic lights, illuminated switches, various sensors, and various indicators.

What is claimed is:

1. A method of producing a nitride fluorescent material, comprising:
preparing a calcined product comprising
a fluorescent material core, and
a first film containing a fluoride on a surface of the fluorescent material core,
bringing the calcined product into contact with a solution containing a metal alkoxide containing an element M2 being at least one element selected from the group consisting of Si, Al, Ti, Zr, Sn, and Zn at a temperature equal to or lower than an ambient temperature and hydrolyzing and condensation-polymerizing the metal alkoxide to form a second film containing an oxide containing the element M2, and
performing a heat-treatment at a temperature higher than 250° C. and equal to or lower than 500° C.,
wherein the nitride fluorescent material comprises the fluorescent material core having a composition containing:
M^{a} being at least one element selected from the group consisting of Sr, Ca, Ba, and Mg,
M^{b} being at least one element selected from the group consisting of Li, Na, and K,
M^{c} being at least one element selected from the group consisting of Eu, Ce, Tb, and Mn,
Al,
N, and
optionally Si.

2. The method of producing a nitride fluorescent material according to claim 1, wherein, in the forming of the second film, the bringing the calcined product into contact with the solution containing the metal alkoxide is performed two or more times.

3. The method of producing a nitride fluorescent material according to claim 1, further comprising drying after the bringing the calcined product into contact with the solution containing the metal alkoxide.

4. The method of producing a nitride fluorescent material according to claim 1, wherein the temperature at which the calcined product is brought into contact with the solution containing the metal alkoxide is higher than 0° C.

5. The method of producing a nitride fluorescent material according to claim 1, wherein ions comprising an element M1, being at least one element selected from the group consisting of alkali metal elements and alkaline earth metal elements, are present when the calcined product is brought into contact with the solution containing the metal alkoxide.

6. The method of producing a nitride fluorescent material according to claim 1, wherein, the bringing the calcined product into contact with the solution containing the metal alkoxide is performed in the presence of a basic catalyst.

7. The method of producing a nitride fluorescent material according to claim 1, wherein the solution containing the metal alkoxide comprises water and/or alcohol.

8. The method of producing a nitride fluorescent material according to claim 1, wherein the metal alkoxide contained in the solution containing the metal alkoxide is in such an amount that an oxide containing the element M2 obtained by hydrolyzing and condensation-polymerizing the metal alkoxide is in an amount of 5% by mass or more and 20% by mass or less relative to 100% by mass of the calcined product.

9. The method of producing a nitride fluorescent material according to claim 1, wherein the metal alkoxide comprises tetraethoxysilane.

10. The method of producing a nitride fluorescent material according to claim 1, wherein, in the preparing of the calcined product, the fluorescent material core has a composition represented by the following formula (I):
M^{a}ᵥM^{b}_{w}M^{c}ₓAl_{3-y}Si_{y}N_{z} (I)
wherein M^{a} represents at least one element selected from the group consisting of Sr, Ca, Ba, and Mg; M^{b} represents at least one element selected from the group consisting of Li, Na, and K; M^{c} represents at least one element selected from the group consisting of Eu, Ce, Tb, and Mn; and v, w, x, y, and z each satisfy 0.8≤v≤1.2, 0.5≤w≤1.8, 0.001<x≤0.1, 0≤y≤0.5, and 1.5≤z≤5.0.

11. The method of producing a nitride fluorescent material according to claim 1, wherein the heat treatment is carried out in air or in an inert gas atmosphere.

12. The method of producing a nitride fluorescent material according to claim 1, wherein the heat treatment is carried out at a temperature in a range of 300° C. to 400° C.

13. The method of producing a nitride fluorescent material according to claim 1, wherein the preparing of the calcined product comprises:
subjecting the fluorescent material core to a first heat treatment performed at a temperature in a range of 120° C. to 500° C. in an atmosphere containing a fluorine-containing substance to prepare the calcined product including the first film on the surface of the fluorescent material core, and
performing the heat treatment according to claim 1 as a second heat treatment.

14. A nitride fluorescent material comprising
a fluorescent material core having a composition containing
M^{a} being at least one element selected from the group consisting of Sr, Ca, Ba, and Mg,
M^{b} being at least one element selected from the group consisting of Li, Na, and K,
M^{c} being at least one element selected from the group consisting of Eu, Ce, Tb, and Mn,
Al,
N, and
optionally Si, and
a film containing an oxide containing an element M2 being at least one element selected from the group consisting of Si, Al, Ti, Zr, Sn, and Zn arranged on the surface of the fluorescent material core,
the nitride fluorescent material having a minimum value of a film thickness ratio Tmin/T in a range of 0.3 or more and 1 or less,
wherein the film thickness ratio Tmin/T is a ratio of a minimum film thickness Tmin of the film derived from the following formula (2) to a film thickness T of the film derived from the following formula (1):
film thickness T=(S2−Sc)/[(P2+Pc)/2] (1); and
minimum film thickness Tmin=(Ss−Sc)/[(Ps+Pc)/2] (2),
wherein, in a scanning electron microscope (SEM) micrograph obtained by photographing a cross-section of the nitride fluorescent material using an SEM, P2 represents an outer circumference length of the film derived from a closed line drawn along the outer circumference of the film to be inscribed on the outer circumference of the film, Pc represents an outer circumference length of the fluorescent material core derived from a closed line drawn along the outer circumference of the fluorescent material core to be inscribed on the outer circumference of the fluorescent material core, Ps represents an outer circumference length of a closed line obtained by enlarging the outer circumference of the fluorescent material core to be inscribed on the outer circumference of the film at the shortest distance from the outer circumference of the fluorescent material core in a direction orthogonal to the outer circumference of the fluorescent material core, S2 represents a cross-sectional area of the fluorescent material core and the film derived from the outer circumference length P2 of the film, Sc represents a cross-sectional area of the fluorescent material core derived from the outer circumference length Pc of the fluorescent material core, and Ss represents a cross-sectional area of the enlarged closed line derived from the outer circumference length Ps.

15. The nitride fluorescent material according to claim 14, wherein an arithmetic average value of the film thickness ratio Tmin/T of the nitride fluorescent materials is in a range of 0.45 or more and 1 or less.

16. The nitride fluorescent material according to claim 14, wherein an arithmetic average value of the film thickness T of the nitride fluorescent materials is in a range of 100 nm or more and 200 nm or less.

17. The nitride fluorescent material according to claim 14, wherein an arithmetic average value of the minimum film thickness Tmin of the nitride fluorescent materials is in a range of 50 nm or more and 100 nm or less.

18. The nitride fluorescent material according to claim 14, wherein a standard deviation of the film thickness T of the nitride fluorescent material is 25 nm or less.

19. The nitride fluorescent material according to claim 14, wherein a median of the film thickness T of the nitride fluorescent materials is 100 nm or more.

20. The nitride fluorescent material according to claim 14, wherein a minimum value of the film thickness T is 70 nm or more.

21. The nitride fluorescent material according to claim 14, wherein a median particle diameter with a cumulative frequency of 50% from a small diameter side in a volume-based particle size distribution measured by a laser diffraction scattering method is in a range of 15 μm or more and 30 μm or less.
